(19) United States
(12) Patent Application Publication
(10) Pub. No.: US 2026/0354617 A1
(43) Pub. Date: Nov. 12, 2026

(54) POWDER AND LIQUID MIXING SYSTEM

(71) Applicant: XIM LLC, Cottonwood Heights, UT (US)

(72) Inventor: Tayler Scharman, Riverton, UT (US)

(73) Assignee: XIM LLC, Cottonwood Heights, UT (US)

(21) Appl. No.: 19/115,041

(22) PCT Filed: Dec. 22, 2023
(86) PCT No.: PCT/US2023/085711

§ 371 Date: Mar. 25, 2025

(51) Int. Cl. A47J 31/40; A47J 31/18

(52) U.S. Cl. CPC A47J 31/404; A47J 31/18

(57) ABSTRACT

A liquid and powder mixing system can include a mix chamber with a reservoir and a liquid powder stirrer, and a hopper situated above the mix chamber to dispense powder. The hopper can dispense the powder through a dispenser hole at a predetermined volume rate, and a scale continuously measures the weight of the powder in the hopper. A stopper that can close the dispenser hole when a desired amount of powder has been dispensed. The system can dispense and mix specific amounts of powder and liquid in under 60 seconds. The hopper can be removable and can be sealed for powder storage when removed. The system can provide for a method of mixing powder and liquid by allowing a user to select a weight amount of powder and a volume of liquid to be mixed, dispensing the powder and liquid at the predetermined rates, and mixing and dispensing the solution.

### CROSS REFERENCE

This application claims the benefit from currently pending U.S. Provisional Application No. 63/435,031 titled “POWDER AND LIQUID MIXING SYSTEM” and having a filing date of Dec. 23, 2022, and all of which is incorporated by reference herein.

### FIELD OF THE INVENTION

The present specification relates generally to devices for mixing powders with liquids and more specifically for a system that automatically mixes powders into a liquid into a hot or cold liquid depending on the user's needs.

### BACKGROUND OF THE INVENTION

Food processors are common on the market today and are designed to mix, cut, chop, blend or otherwise process foods and powders. Given the advent of health-conscious individuals, there are people that are prioritizing their eating and drinking habits. As such, people are buying accessories to accompany this healthy lifestyle to help make their food and drinks easier for consumption. Individuals have developed regular fitness regimes that ensure they eat properly, exercise daily and get the proper nutrition for their bodies to recover. Recovery can be assisted by mixing protein and vitamin powders into their diet. These powders are often mixed with food or liquids and are usually consumed in the morning or close to the time of exercise.

Since these proteins and vitamins are mixed into liquid it is common that proteins and vitamins are stored separate from the liquid until the time of consumption. Various products have been developed to assist in mixing these powders in with the liquids. For instance, some powders are mixed in bottles that are what contain a whisking ball that when the bottle is shaked the whisking ball moves vigorously within the bottle mixing the powder within the liquid. Other bottles have a main container housing that stores the liquids and a housing to store the powders and allows the user to release the powder into the liquid when ready for use and then uses an impeller to mix the powder into the liquid, which requires the user to constantly wash and add more liquid and powder into the housings. Further, adding ice into the container requires the user to mix the powder into the liquid first, and then add ice after the mixing is complete.

Therefore, there is a need for a system that can cool and heat liquid and can mix efficiently powder and liquid together and then dispense it for the user.

### BRIEF SUMMARY OF THE INVENTION

Accordingly, the present comprises a liquid and powder mixing system comprising a mix chamber with a reservoir and a liquid powder stirrer, configured to hold a predetermined amount of at least one liquid. The system can include a hopper situated above the mix chamber to dispense at least one powder into the mix chamber at a predetermined volume rate. The hopper can be equipped with a dispenser hole and a stopper that closes the dispenser hole when a desired amount of powder has been dispensed.

The system can also include a scale that can continuously measure the weight of the at least one powder in the hopper. The system is capable of dispensing 0-90 grams of the at least one powder into the at least one liquid and mixes the at least one powder with the at least one liquid in under 60 seconds. The hopper can be removable and can be sealed with an airtight lid and an airtight cap to allow the at least one powder to be stored when the hopper is removed from the system.

The system can further include a dosage wheel with at least one slot of a predetermined volume. The rotation of the slot over the dispenser hole dispenses the predetermined volume to the mix chamber. A scraper can be coupled in the hopper to scrape the top of the dosage wheel to ensure the appropriate volume is dispensed. A stirrer is situated in the hopper to declump the at least one powder as it is being dispensed. The at least one slot and the dispenser hole are substantially the same shape, and the dosage wheel has a depth between 1/16 of an inch and ¼ of an inch. The volume of the at least one slot is between 0.75 and 1.5 milliliters. The hopper and the reservoir can be removable and can be dishwasher safe. The dosage wheel can be a plurality of dosage wheels having different numbers of slots with different powder dispensing rates.

The disclosure also provides a method of mixing at least one powder with at least one liquid. The method can include providing a mix chamber, a hopper, and a scale, allowing a user to select a weight amount of powder and a volume of liquid to be mixed, dispensing the powder at the predetermined volume rate, and ceasing dispensing when the selected weight amount of powder has been dispensed.

The method further includes mixing the volume of liquid and the weight amount of powder, and dispensing the mixed solution. The method may further include stirring the powder as it is being dispensed, providing a slide valve at the dispenser hole, and closing the slide valve when the selected amount of powder has been dispensed. The method may also include providing a dosage wheel to the hopper, allowing a user to select one of the plurality of dosage wheels based on the amount of powder to be dispensed, and rotating the selected dosage wheel over the dispenser hole to dispense the predetermined volume to the mix chamber. The method can have a cooling or heating element thus heating or cooling the volume of liquid and providing the liquid to the mixing chamber, scraping the top of the slot before the slot is rotated over the dispensing hole, and providing a plurality of hoppers for storing a plurality of powders.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of a powder mixing system in accordance to one, or more embodiments;

FIG. 2 is a bottom view of the powder mixing system in accordance to one, or more embodiments;

FIG. 3a is a front view of the powder mixing system in accordance to one, or more embodiments;

FIG. 3b is an cross-sectional view of FIG. 3a of the powder mixing system in accordance to one, or more embodiments;

FIG. 4 is a side view of the powder mixing system in accordance to one, or more embodiments;

FIG. 5 is an side isometric exploded view omitting the housing in accordance to one, or more embodiments;

FIG. 6a is a front view of the powder mixing system omitting the housing in accordance to one, or more embodiments;

FIG. 6b is an cross sectional exploded side view of the powder mixing system omitting the housing in accordance to one, or more embodiments;

FIG. 7 is an exploded isometric view of the powder mixing system in accordance to one, or more embodiments;

FIG. 8 is an isometric view of a powder dispensing hopper in accordance to one, or more embodiments;

FIG. 9a is an exploded front view of the powder dispensing hopper in accordance to one, or more embodiments;

FIG. 9b is a cross section exploded view of FIG. 9a of the powder dispensing hopper in accordance to one, or more embodiments;

FIG. 10 is an exploded front isometric top view of the powder dispensing hopper in accordance to one, or more embodiments;

FIG. 11 is an exploded front isometric bottom left view of the powder dispensing hopper in accordance to one, or more embodiments;

FIG. 12 is an exploded front isometric bottom right view of the powder dispensing hopper in accordance to one, or more embodiments;

FIG. 13 is a bottom view omitting the motor components of the powder dispensing hopper in accordance to one, or more embodiments;

FIG. 14 is a side view of the powder dispensing hopper in accordance to one, or more embodiments;

FIG. 15a is a front view of the powder dispensing hopper in accordance to one, or more embodiments;

FIG. 15b is the cross-sectional view of FIG. 15a of the powder dispensing hopper in accordance to one, or more embodiments; and

FIG. 16 is the isometric view of the powder dispensing hopper showing a powder mixing device in accordance to one, or more embodiments.

FIG. 17 is an isometric view of the assembled mixing chamber assembly in accordance to one or more embodiments;

FIG. 18a is a front view of the mixing chamber assembly in accordance to one, or more embodiments;

FIG. 18b is a cross-sectional view of the mixing chamber of FIG. 18a;

FIG. 19 is exploded perspective view of the mixing chamber assembly in accordance to one, or more embodiments;

FIG. 20 is an overhead view of the fluid reservoir of the mixing chamber assembly of FIG. 3;

FIG. 21 is an exploded perspective view of the lid of the mixing chamber assembly in accordance to one, or more embodiments;

FIG. 22 is a perspective view of the mixer of the mixing chamber assembly in accordance to one, or more embodiments;

FIG. 23 is an exploded overhead perspective view of the mixer of FIG. 22; and

FIG. 24 is an exploded bottom view of the mixer of FIG. 22.

FIG. 25 is a front isometric view of the liquid storage system in accordance to one, or more embodiments;

FIG. 26a is a back view of the liquid storage system in accordance to one, or more embodiments;

FIG. 26b is a cross-sectional view of FIG. 26a of the liquid storage system in accordance to one, or more embodiments;

FIG. 27 is a bottom view of the liquid storage system in accordance to one, or more embodiments;

FIG. 28 is a top view of the liquid storage system in accordance to one, or more embodiments;

FIG. 29a is a exploded front view of the liquid storage system in accordance to one, or more embodiments;

FIG. 29b is a cross sectional view of FIG. 29a of the liquid storage system in accordance to one, or more embodiments;

FIG. 30 is an exploded front isometric view of the liquid storage system in accordance to one, or more embodiments;

FIG. 31a is a front view of the liquid storage system and a heating and cooling system in accordance to one, or more embodiments;

FIG. 31b is a cross-sectional view of FIG. 31b of the liquid storage system and a heating and cooling system in accordance to one, or more embodiments;

FIG. 32 is a front view of the liquid storage system and a heating and cooling system in accordance to one, or more embodiments;

FIG. 33 is a bottom view of the liquid storage system and a heating and cooling system in accordance to one, or more embodiments.

FIG. 34a is a front view of the cooling and heating system in accordance to one, or more embodiments;

FIG. 34b is a cross-sectional view of FIG. 34a of the cooling and heating system in accordance to one, or more embodiments;

FIG. 35 is a bottom isometric view of the cooling and heating system in accordance to one, or more embodiments;

FIG. 36 is a top view of the cooling and heating system in accordance to one, or more embodiments; and

FIG. 37 is an isometric view of the mixing chamber assembly in accordance to one, or more embodiments;

FIG. 38 is a isometric view of the top assembly in accordance to one, or more embodiments;

FIG. 39 is a bottom view of the top assembly in accordance to one, or more embodiments;

FIG. 40 is a top view of the top assembly in accordance to one, or more embodiments;

FIG. 41 is a top view of the top assembly in accordance to one, or more embodiments; and

FIG. 42 is an electrical flow chart of the powder mixing system in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

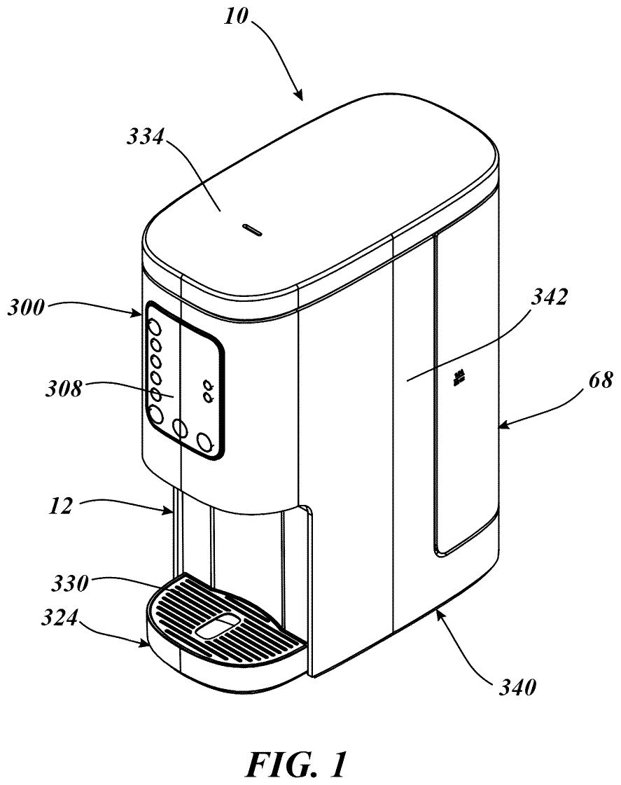

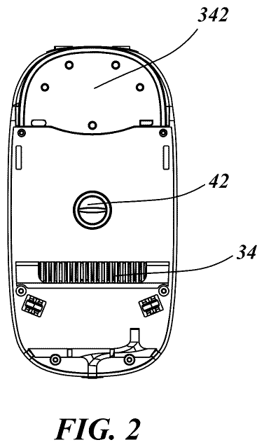

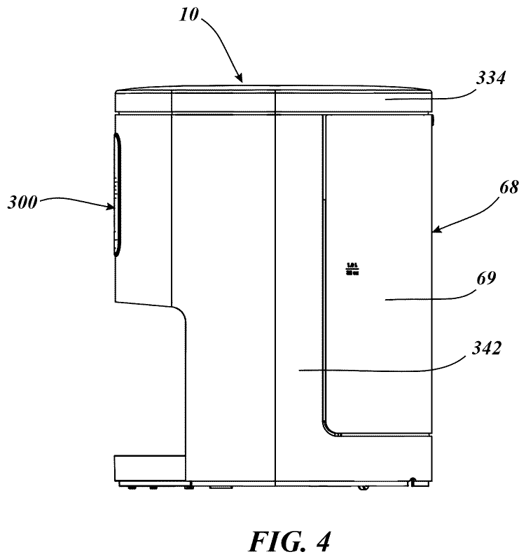

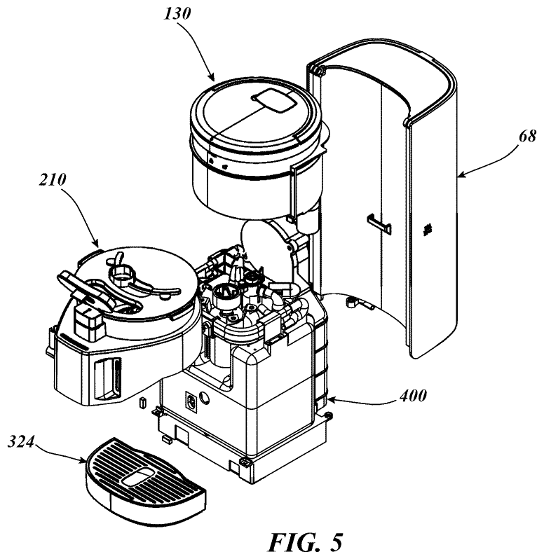

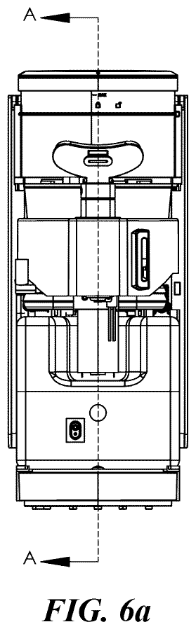

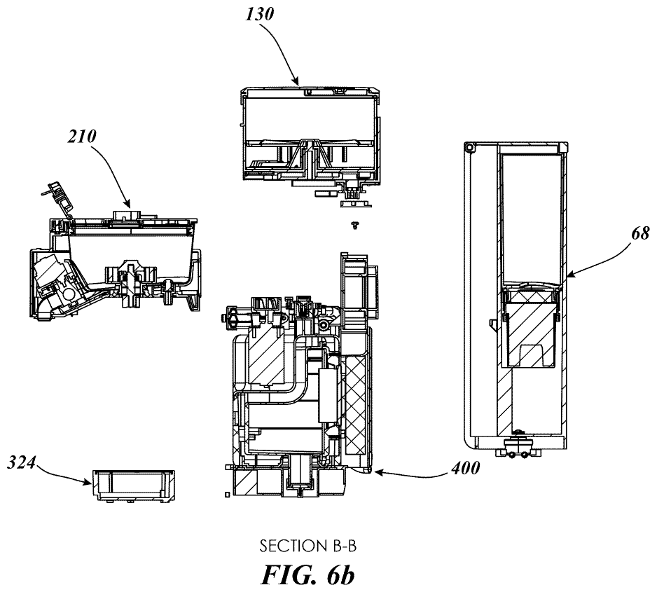

Referring initially to FIG. 1-7 a powder and liquid mixing system is shown generally at 10. A liquid and powder mixing system 10 comprises a mix chamber 210 that includes a mix reservoir 214 and a liquid powder stirrer 270. The mix reservoir 214 is designed to hold a predetermined amount of at least one liquid. The system also includes a hopper 130 situated above the mix chamber 210, which dispenses at least one powder into the mix chamber. The hopper 130 dispenses the powder through a dispenser hole at a predetermined volume rate. The powder and liquid mixing system 10 can comprise the following components, a liquid filtration device 68, a powder dispensing hopper 130, a bottom assembly 12, mixing chamber 210, a heating and cooling system 400, a front assembly 300 and a drip tray assembly 324.

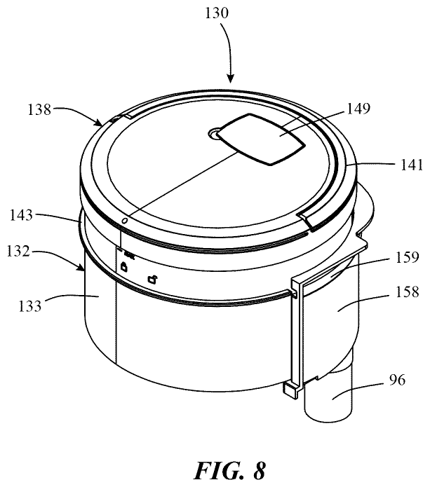

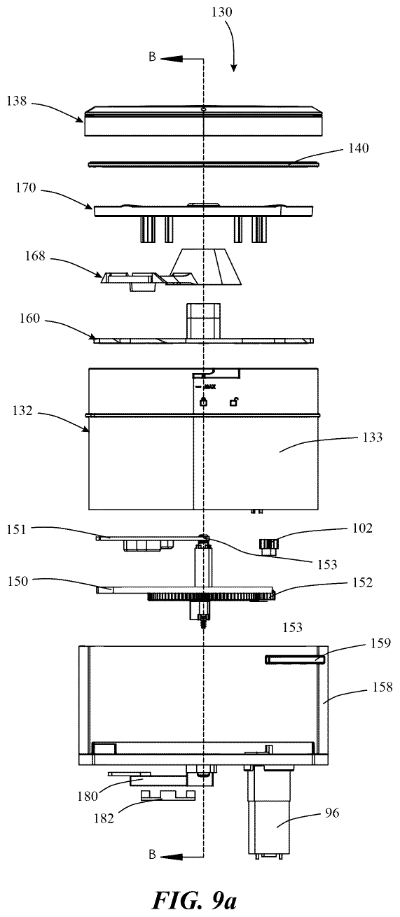

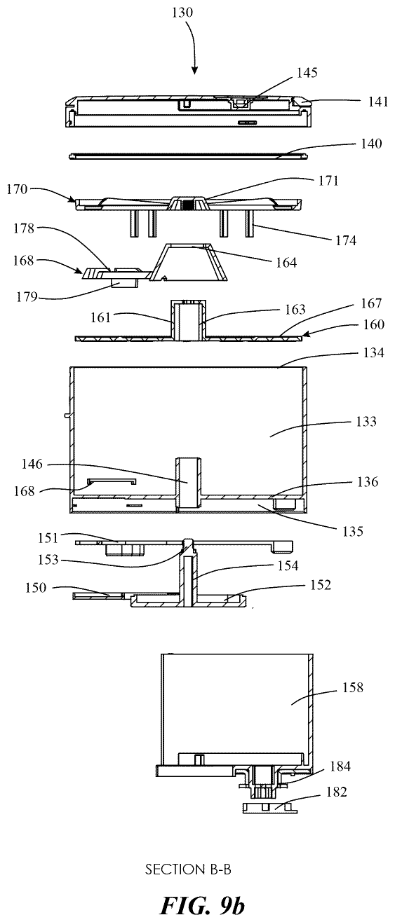

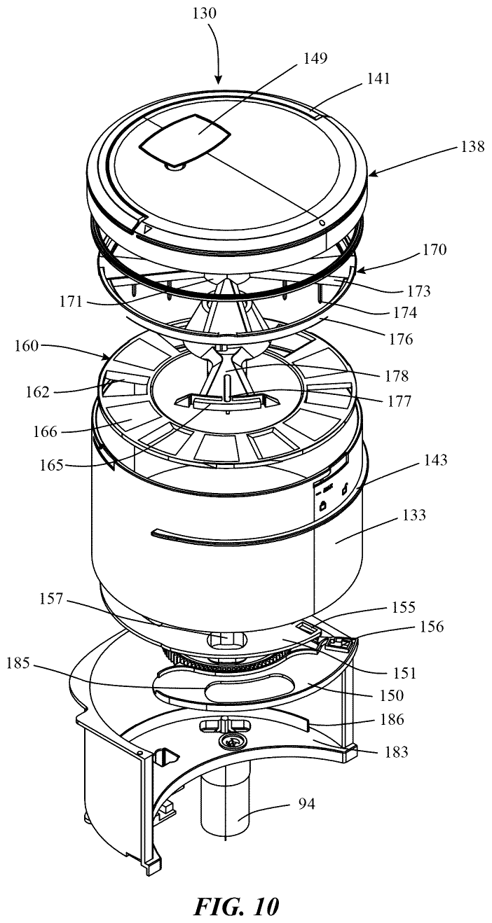

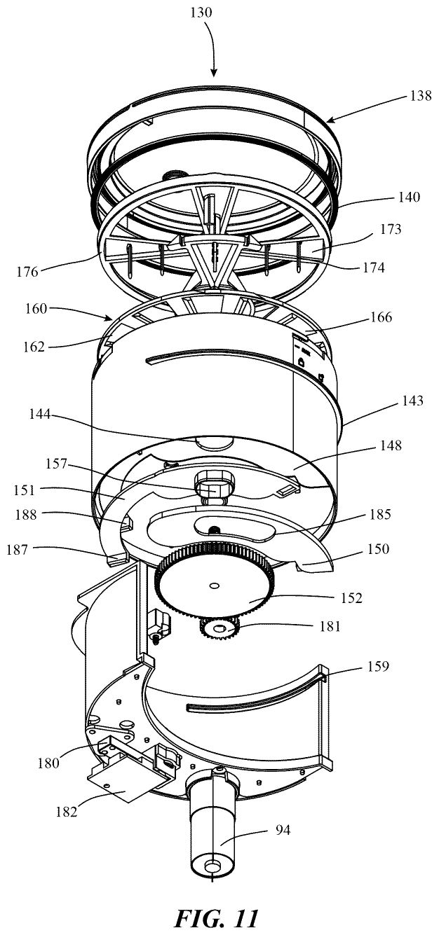

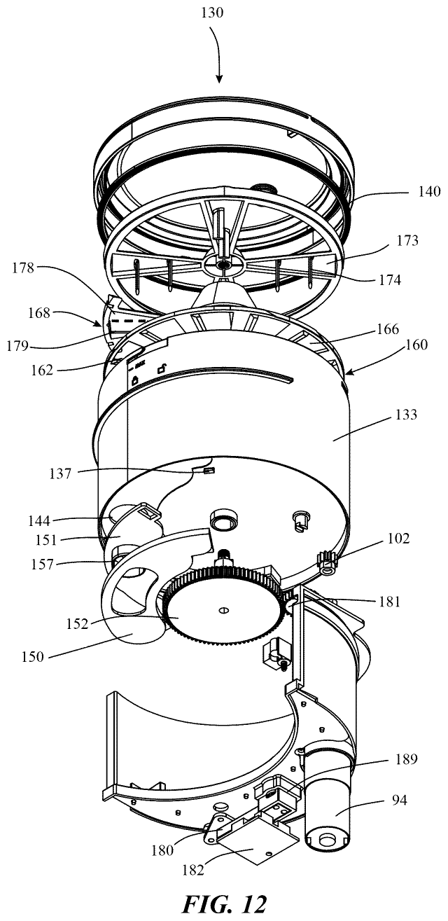

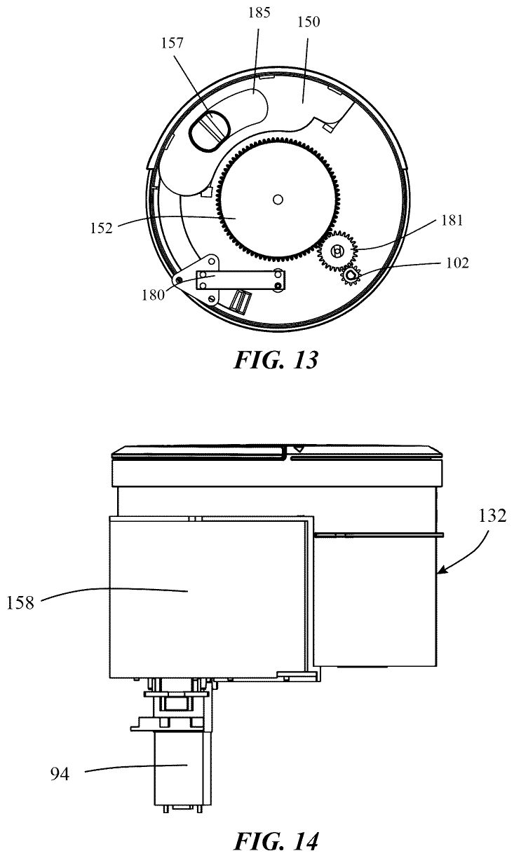

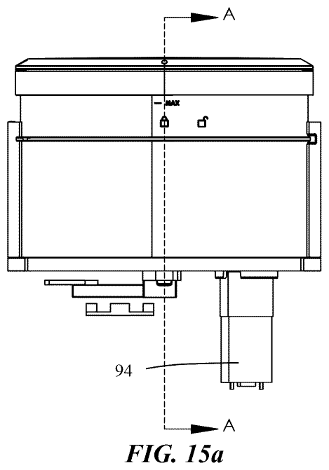

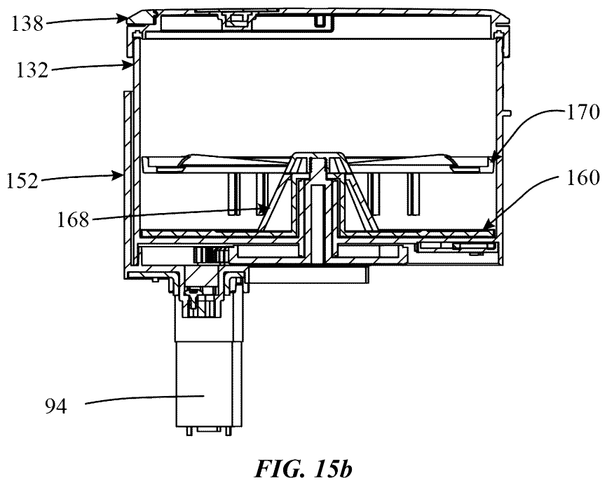

Referring to FIG. 8-15 a powder dispensing hopper is shown generally at 130. The powder dispensing hopper 130 can comprise a powder reservoir 132 having a bottom 136 that includes a dispenser hole 144 for dispensing powder from the reservoir. The reservoir 132 also includes a wall 133 that rotates with the bottom 136. The powder reservoir 132 can have an open end 134 and a bottom 136 which can be a partially closed end, which can have a wall 133 between the open end and bottom. The wall 133 can partially extend beyond the bottom forming a ledge 135 on the bottom of the reservoir 132. The wall 133 can have a reservoir guide rail 143 on its outer diameter that can partially extend beyond the outer diameter.

The open end 134 can be configured to partially or fully accept a lid 138 wherein the lid can have a gasket 140 around its outer diameter to keep the hopper from leaking powder out of the reservoir 132 and can create an airtight seal in the reservoir 132 to keep the powder within the hopper fresh. The lid 138 can be any suitable shape such as, for example, a circle, square, rectangle, or the like, but in the preferred embodiment it can be in the circular shape. The lid 128 can be removably attached to the reservoir 132 by such as, for example, twist with hook and grooves, snaps, fasteners, or the like. The lid 128 can have a lid hole 145 allowing the user access to the reservoir without removing the lid completely off the reservoir 132. The lid hole 145 can be covered with a lid hole cover 149 that is rotatably coupled to the lid and in certain embodiments at least one of the lid hole or lid hole cover can be omitted and the lid can have a seal such as an O-ring or gasket coupled to it. The lid 138 can further comprise a handle 141 wherein the rotatable handle can be rotatably coupled to the lid.

In embodiments, the reservoir 132 can be any suitable shape such as, for example, circular, square, hexagon, or the like, but in the preferred embodiment the reservoir is circular. The bottom 136 can have a gear hole 146 and the dispenser hole 144 wherein the gear hole can be substantially centered on the bottom and the dispenser hole can be substantially near the outer diameter of the reservoir or located at any suitable location but in the preferred embodiment it is located under a paddle 178 of a scrapper 168 which can be a blade fixator. The bottom 136 can have an access slide slot 148 which can partially cut into the bottom and can extend partially around the outer circumference of the bottom. The bottom 136 can have at least one access slide retainers 137 integral or coupled to it which can allow an access guide 150 to be attached to the bottom with the access slide 151 coupled between the access guide and the bottom allowing the reservoir 132 and the access guide to rotate keeping the access slide stationary which can selectively open and close the access hole 157 dispensing the powder or retaining the powder within the reservoir. In certain embodiments the bottom 136 can be flush with the wall 133.

In embodiments, the powder dispensing hopper 130 can further comprise a dosage wheel 160 within the reservoir 132, which has at least one slot 162 at a predetermined volume wherein in the preferred embodiment the slots can give an accurate dose of the powder. The slot 162 can give a consistent dosing allowing at least between 1 gram to 10 gram and more preferable 1.5 grams to 5 grams and still more preferably 2 grams. In the preferred embodiment the dosage wheel 160 can have 6 slots or 12 slots allowing for a more consistent dose and the ability to weigh the dose as it falls into a mixing chamber 200. The dosage wheel 160 can be circular having at least one channel 166 and the last least one slot space axial around the dosage wheel. A motor 96 is provided to rotate the dosage wheel 160 within the reservoir 132.

The motor 96 can be coupled to a main gear 152 that can include a main gear shaft 154 that can be rotatably coupled to the dosage wheel 160 and a stir wheel 170. The dosage wheel 160 can comprise a base shaft 163 with a hole 165 in its center wherein the base shaft can extend vertically from the dosage wheel platform. In certain embodiments, the dosage wheel 160 can have an outer ring and an inner ring which can be connected by the at least one channel 166 positioned axially around the inner and outer rings leaving the at least one slot between the channels and in other embodiments the channels can be omitted leaving the dosage wheel flat on top between the slots. The channels 166 can be separated by at least one slot 162 positioned axially around the dosage wheel allowing the powder to be dropped into the mixing chamber 200 at an accurate and even dose so that a scale which can be a force sensor can weigh the powder that is entering the mixing chamber. The scale can continuously measure the weight of the powder in the hopper which can be a reservoir 132. A stopper 151 which can be an access slide is also included in the system, which closes the dispenser hole 144 when a desired amount of powder has been dispensed into the mix chamber. The system is capable of dispensing 0-90 grams of the powder into the liquid and mixes the powder with the liquid in under 60 seconds.

In embodiments, the powder dispensing hopper 130 can further comprise an access guide 150 that can be coupled to the bottom 136 such that the access guide can be coupled to the bottom wherein the access guide and reservoir can rotate relative to an access slide 151. The access slide 151 can have an access hole 157 that can selectively align with the dispenser hole 144 to allow powder to be dispensed from the dispenser hole and access hole. In certain embodiments, the access slide 151 can move relative to the access guide 150 and/or reservoir 132. The access hole 157 can align and mate up with a mixing chamber inlet 240 wherein the mixing chamber inlet can capture the access hole and limit its movement by allowing the mixing chamber inlet to move on guides within an inlet guide 233 which can selectively open and close the hole allowing powder to be dispensed into the mixing chamber 200.

In embodiments, the powder dispensing hopper 130 can further comprise a main gear 152 wherein the main gear can comprise a main gear shaft 154 extending from at least one side of the main gear and in the preferred it extends towards the reservoir 132. The main gear shaft 154 can be circular and at least partially in the shape of such as for example, x-shape, t-shape, y-shape, or the like and in certain embodiment the main gear shaft can have threads 153 on its top portion. The main gear 152 can come into contact with or be coupled to a motor gear 102 which can come into contact with a hopper third gear which can be attached to a motor 96. The main gear 152, a motor gear 102 and a secondary gear 181 can be such as, for example, bevel gears, spur gears, miter gears, screw gears, or the like. The motor 96 can be such as, for example, AC motor, DC motor, brushless motor, stepper motor, or the like. The motor 96 can be controlled by the user at a set speed or at a variable speed. The motor 96 can be coupled to a motor support 184 wherein the motor support can be coupled to a reservoir holder 158.

The motor gear 102 can come into contact with the secondary gear 181 which can come into contact with the main gear which can create a gear ratio of such as, for example, 1:2, 1:3, 1:5, 1:10, 1:20, 1:30, 2:1, 3:1, 5:1, 10:1, 20:1, 30:1 or the like thus either increase or decreasing the speed of the dosage wheel 160 and the stir wheel 170. The main gear shaft 154 can be rotatably coupled to the dosage wheel 160 and the stir wheel 170 wherein the main gear shaft can rotate freely within the gear hole 146. The main gear shaft 154 can be coupled to a dosage wheel 160 and a stir wheel 170 wherein the dosage wheel can comprise a base hole 163 substantially centered on the blade base wherein the base hole can substantially match the main gear shaft 154 allowing the dosage wheel to rotate as the main gear 152 rotates by the motor 96.

The stir wheel 170 can comprise a cap 171 that can have a pocket or thread 172 that can substantially match the main gear shaft 154 allowing the stir wheel to rotate as the main gear rotates. The cap 171 and the blade hole 163 can be such as, for example, circular shape, x-shape, t-shape, y-shape, threaded or the like allowing the main gear shaft 154 to couple to the cap and the base hole 163. The stir wheel 170 includes at least one stir blade 173 having at least one stir tooth 174 on each at least one blade. The scrapper 168 can remain stationary as the stir wheel 170 and dosage wheel 160 rotate within the hopper container.

In embodiments, the stir wheel 170 can be attached to the main gear shaft 154 wherein the hopper blade can have a corresponding hole that matches the shape and size of the main gear shaft 154. The main gear shaft 154 can be coupled to the stir wheel 170 by such as, for example, press fit, fasteners, adhesive, or the like wherein the hopper blade can fit within the reservoir 132 and can rotate within the hopper container's inner diameter. The stir wheel 170 can have an outer diameter and an inner diameter and can take on any suitable shape or size, but in the preferred embodiment it is substantially the same shape. The stir wheel 170 can have at least one at least one stir blade 173 and at least one stir tooth 174, extending from the stir blade on each stir blade, spaced evenly or unevenly around the stir wheel.

In embodiments, the stir wheel 170 can further comprise at least one stir blade 173 extending outwardly from the cap 171 and ending at a first outer ring 176 and at least one tooth on each rotor blade. In the preferred embodiment the first outer ring 176 can have an integral upper ring and a lower ring wherein the lower ring can have a substantially smaller diameter than the upper ring. The stir blades 173 can be coupled to or apart of the lower ring and/or upper ring wherein the stir blades can be a flat and can be evenly spaced axially around the stir wheel 170. In other embodiments the upper ring and lower ring can be one solid ring and the stir blades 173 can be coupled to the outer ring. In embodiments, the at least one tooth 174 can extend from the bottom of the at least one stir blade 173 allowing the teeth to mix and scrap the excess powder from dosage wheel 160 aiding in consistent powder being dispensed into a mixing chamber 200.

The dosage wheel 160 can comprise a dosage wheel outer ring and a dosage wheel inner ring wherein the dosage wheel inner ring can have a plateau 167 a guide shaft 161 having a base hole 163 wherein the guide shaft can extend vertically from the plateau. The blade base outer ring and the blade base inner ring can be connected by at least one dosage wheel channel 166 positioned axially around the inner and outer ring, wherein the blade base channels can be recessed or flush from the top edge of the blade base outer ring and can be separate pieces or integral to the blade base outer ring and blade base inner ring. The at least one dosage wheel channel 166 can be separated by at least one slot 162 positioned axially with the blade base channels wherein the holes allow powder to be dropped into the mixing chamber (not shown).

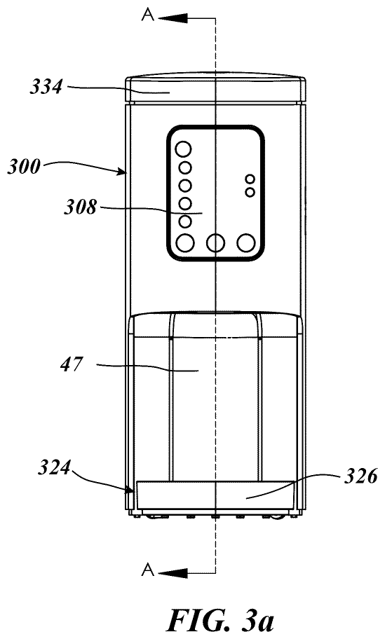

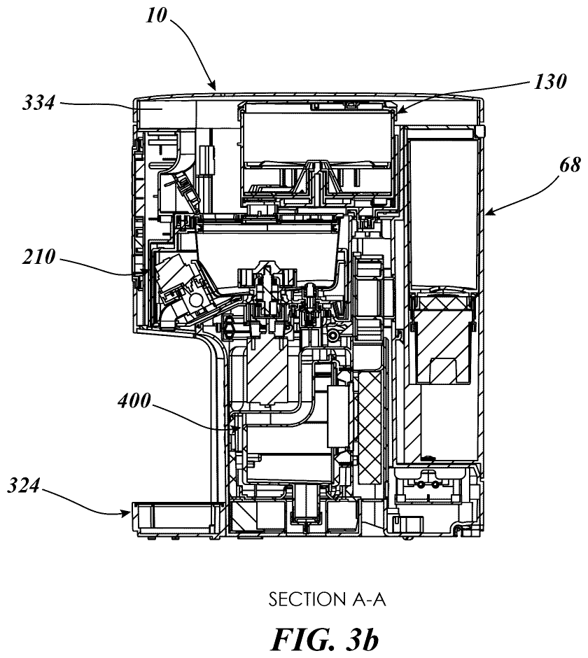

The scrapper which can be a blade fixator 168 can be any suitable shape having at least one paddle 178 with a flap 179 extending from the paddle towards the dosage wheel 160. The scrapper 168 can level the powder that is in the slot 162 and keep additional powder from dropping into the mixing chamber 200 as it releases the powder. In the preferred embodiment the scrapper 168 can have the same shape or substantially the same shape as shown in FIG. 3. The scrapper 168 can comprise a blade center hole 164 wherein the blade center hole can loosely fit around the main gear shaft 154 allowing the scrapper to stay stationary while the stir wheel 170 and dosage wheel 160 can rotate freely within the reservoir 132. The scrapper 168 can stay stationary by at least one blade capture point 169 wherein the capture point can partially extend from the inner diameter of the reservoir 132 capturing the end 165 of the scrapper within the reservoir 132. The at least one blade capture 169 can be such as, for example, a ledge, hook, platform, or the like that can extends from the inner diameter of the reservoir 132 and can capture the end of the paddle 165 of the scrapper 168. The scrapper or scrapper 168 can ensure that the appropriate volume is dispensed when the slot 162 is rotated over the dispenser hole 144.

The at least one paddle 178 can have a paddle slot 177 which can be coupled to a flap 179. The flap 179 can be made from such as, for example, silicone, plastic, rubber, or the like. The flap 179 can come into contact with the dosage wheel 160 wherein when the dosage wheel rotates the flap can push any excess powder off of the at least one dosage wheel channel 166 into the at least one slot 162 dispensing the powder evenly into the mixing chamber 200. The dosage wheel 160 has a depth between 1/16 of an inch and ¼ of an inch. The volume of the slot 162 is between 0.75 and 1.5 milliliters. The hopper and the reservoir are removable and dishwasher safe. The dosage wheel 160 is a plurality of dosage wheels having different numbers of slots having different powder dispensing rates such as, for example, at least one to 20 slots.

The reservoir holder 158 can have a reservoir shelf 183 and a reservoir shelf guide 186 which can align the reservoir 132 when placed into the reservoir holder. The reservoir holder 158 can further comprise a reservoir guide 159 which aligns with the reservoir guide rail 143 and guides the reservoir as it rotates. The reservoir guide 159 can extend partially around the reservoir holder 158. In the preferred embodiment the reservoir holder 158 can have a force sensor mount 189 which can have the force sensor 180 coupled to it.

In embodiments, the access slide slot 148 can be any suitable shape but in the preferred embodiment it can match the shape of the access guide 150. The access guide 150 can be attached to the bottom 136 by at least one access slide retainer 137 wherein the hook can be such as, for example, a snap hook, mounting boss, hook groove, fasteners, adhesive or the like. The access guide 150 can fully or partially contain the access slide 151 and the access guide can have an access guide slot 185 wherein the access hole can be partially inserted into and slide within the access guide slot. The access slide 151 can cover the dispenser hole 144 when not dispensing the powder and can remain in its closed or covering position when not attached, and/or stored away from the powder dispensing system (not shown).

The access slide 151 can comprise at least one cover magnet 155 and the access guide 150 can have at least one slide magnet 156 wherein the magnets can keep the access slide shut when not in use and when the dispensing the slider, having the access hole 157, can be aligned with the dispenser hole 144 allowing the powder to dispense the powder through both holes into the mixing chamber 200. The access slide 151 can further comprise a access slide tab 187 which can removably contact or permanently contact a bottom tab 188 which can extend from the reservoir bottom 136 which can allow the access slide to selectively rotate with the reservoir at least zero to forty-five degrees or in other embodiment keep the access slide stationary. In certain embodiments the at least one cover magnet 155 and the slider magnet 156 can be omitted.

In embodiments, the opening and closing of the access slide 151 on the bottom 136 protects the powder from steam (when mixing hot drinks) or mist and protects from possible splashing during mix cycles. The access slide 151 can let users completely detach and store the dispensing powder hopper 130 elsewhere without having any powder leaked or spilled from the bottom while removing it or storing it or can have multiple dispensing powder hopper with different powders for different applications. It also protects the powder by reducing the amount of air/light exposed to the powder.

In embodiments, the powder hopper assembly 130 can further comprise at least one force sensor 180 which can be such as, for example, load cell, strain gauges, single point, planar beam, s-type, or the like. The force sensor 180 can be coupled to the reservoir 132 or reservoir holder 158 or located near the reservoir on the force sensor mount 189 which can be located on the reservoir holder 158. The force sensors 180 can measure the difference in weight between the nominal weight of just of the reservoir 132, the reservoir holder 158 and any other component connected to the reservoir and the reservoir holder 158 and the delta between the nominal weight and each time powder is distributed into the mixing chamber 200 allowing the user to control in fine increments the amount of powder being dispensed. For example, if the reservoir 132 weighs 400 grams, the user wants to dispense 20 grams, when dispensing, the force sensors 180 can calculate the overall change in weight and when the hopper container reaches the set weight the motor 96 will stop rotating and the access slide 151 will close. The motor 96 can rotate the dosage wheel 160, the stir wheel 170 at a user or computer specified speed allowing fluid movement through the powder thus evenly dispensing the powder through the dispenser hole 144 and allowing different size granular powders to be easily dispensed.

The hopper 130 in the system can be removable. The system also includes an airtight lid 138 that can seal the top of the hopper and an airtight cap or access slide 151 that can seal the dispenser hole 144 of the hopper. This allows the powder to be stored in the hopper when the hopper is removed from the system.

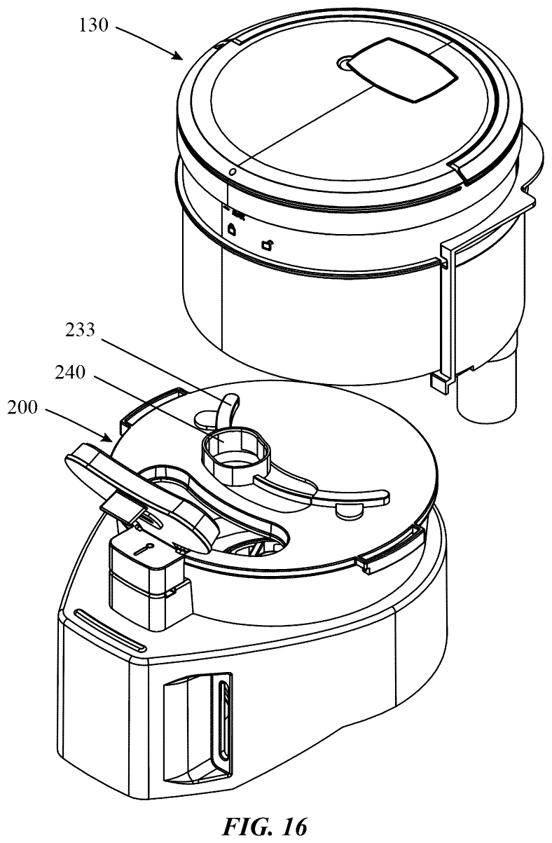

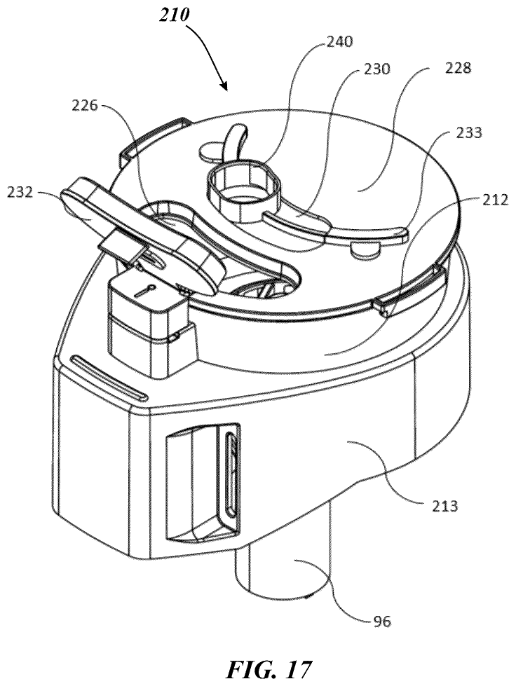

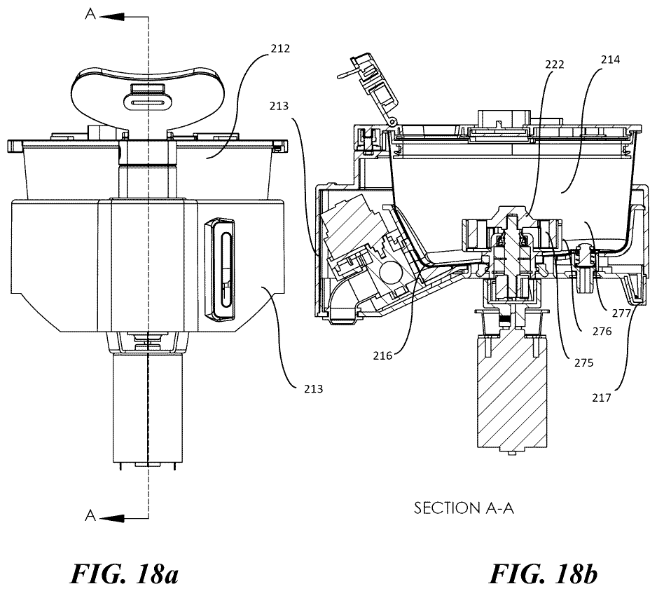

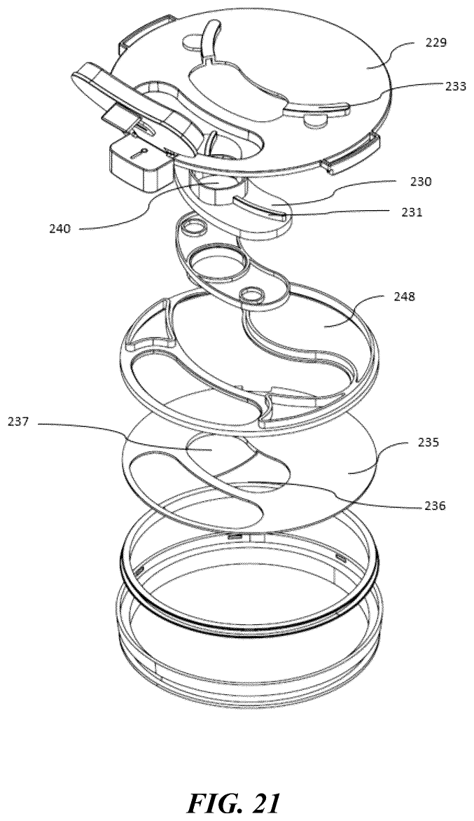

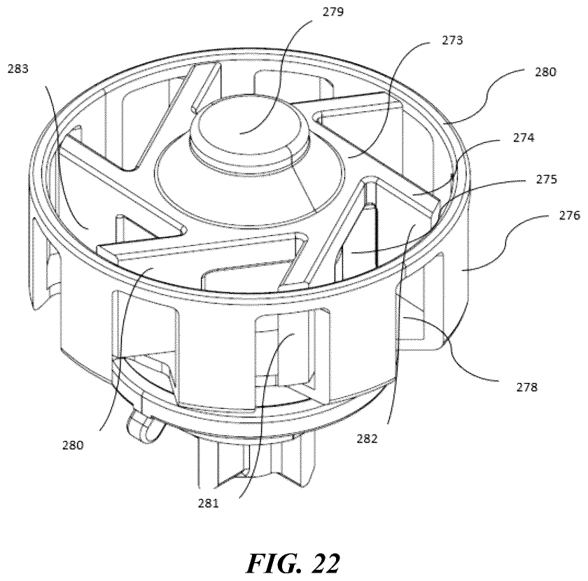

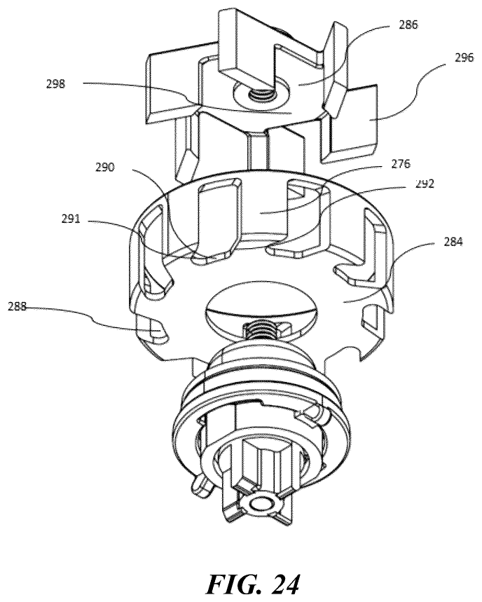

Referring initially to FIG. 16-24 a mixing chamber system is shown generally at 210. The mixing chamber 210 can comprise fluid reservoir 212 in a base 213. The fluid reservoir 212 is a container designed to hold the fluid to be mixed. The fluid reservoir 212 can be made of any suitable material that is resistant to the fluid to be mixed. The fluid reservoir 212 can be of any suitable size and shape, depending on the volume of fluid to be mixed.

The fluid reservoir 212 can be a shell having an interior 214 and an external surface 224. The fluid reservoir 212 can have an open top 229 and a lid 228. In embodiments, the fluid reservoir 214 can contain a mixer 270 having a wall 276 defining a mixing interior portion 275 and a mixing outer portion 277. The wall can be a columnar ring or any other suitable shape or cross section. The wall 276 may have at least one cutout 278. The wall cutouts can be of any suitable size and shape, and can be arranged in any suitable pattern on the wall of the ring. In a particular embodiment, the wall 276 has nine evenly spaced cutouts 278. The wall cutouts 278 allow the fluid to flow from the inner portion 275 to the outer portion 277 of the fluid reservoir 212, thereby facilitating the mixing of the fluid.

The wall 276 of the mixer 270 may be fixed and mixer 270 may have a stirrer 273 rotatably coupled in the interior portion 275. The stirrer 273 has a center 279 and a plurality of paddles 274. Each paddle 274 has a front surface 280, a rear surface 282, and a front edge 281 that extends nearly to the wall 276. The rear surface 282 of a first paddle and the front surface 280 of a second paddle define a mixing space 283. The rotation of the paddles 274 pushes the fluid from the mixing space 283 through one of the wall cutouts 278 into the outer portion of the fluid reservoir 212. The paddles 274 can create a high shear for particle size reduction that does not require a massive amount of power to effectively product the same output of a traditional blender blades.

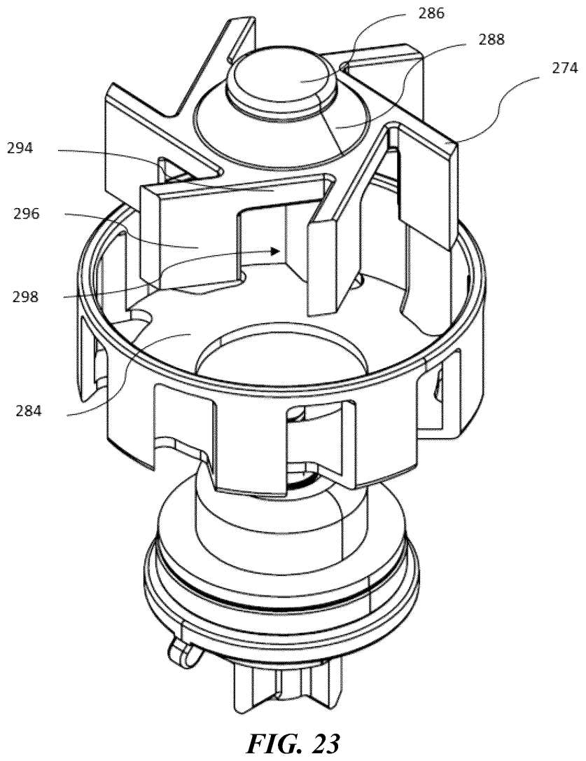

Referring to FIG. 23, the inner portion 275 of the mixer 270 has a bottom 284 and the stirrer 273 has a top 286. Each of the paddles 274 of the stirrer 270 has a connector portion 294 and a stirring portion 296. The connector portion 294 extends from the top 286 of the stirrer 273 toward the bottom 284 of the inner portion 275 of the fluid reservoir 212. The stirring portion 296 extends farther from the top 286 of the stirrer 273 toward the bottom 284 of the inner portion 275 of the fluid reservoir 212. The stirring portion 296 defines an open interior 298 of the stirrer.

The top of the stirrer 273 may have a substantially circular central portion 288. The connector portion 294 of each paddle 274 extends radially from a tangent to the circular central portion 288. The stirring portion 296 of each paddle 274 extends radially from the connector portion 294. The central portion 288 of the stirrer may be coextensive with the open interior 298 of the stirrer. The front edge 281 of each paddle may be angled. That is, the intersection of the front edge 281 with the rear surface 282 may extend radially farther than the intersection of the front edge 281 with the front surface 280 of the paddle 274. The front edge 281 of each paddle may alternatively be contoured to match the curve of the wall 276 of the mixer 270.

The mixer bottom 284 may be held above the reservoir bottom 266. The mixer bottom 284 may have a floor cutout 288 that extends from the wall cutout. The floor cutout 288 has a front 290, a first side 291, and a second side 292. The first side 291 meets the wall 276 of the mixer 270 at a substantially acute angle and the second side 292 meets the wall 276 at a substantially obtuse angle.

The fluid mixer is designed to mix at least one liquid with at least one powder. The fluid mixer further comprises a liquid inlet 216. The liquid inlet 216 is used to introduce the liquid into the fluid reservoir 212. The powder inlet 240 is used to introduce the powder into the fluid reservoir 212. The liquid inlet 216 introduces the liquid into the outer portion 277 of the fluid reservoir 212. The powder inlet 240 is at least partially above the inner portion 275 of the fluid reservoir 212. When the powder is introduced through the powder inlet 240, at least a portion of the powder falls into the inner portion 275 of the fluid reservoir 212. The fluid mixer further comprises a liquid measurer and a powder measurer. The liquid measurer is used to allow a predetermined amount of the liquid to be introduced into the fluid reservoir. The powder measurer is used to allow a predetermined amount of the powder to be introduced into the fluid reservoir.

The motor 96 is used to rotate the stirrer 273. The motor 96 can be of any suitable type, such as an electric motor, a hydraulic motor, a pneumatic motor, or the like. The motor can be connected to the stirrer in any suitable manner, such as by a direct connection, a belt drive, a chain drive, a gear drive, or the like. The motor 96 can be controlled to rotate the stirrer 273 at any suitable speed, depending on the type of fluid to be mixed and the desired degree of mixing.

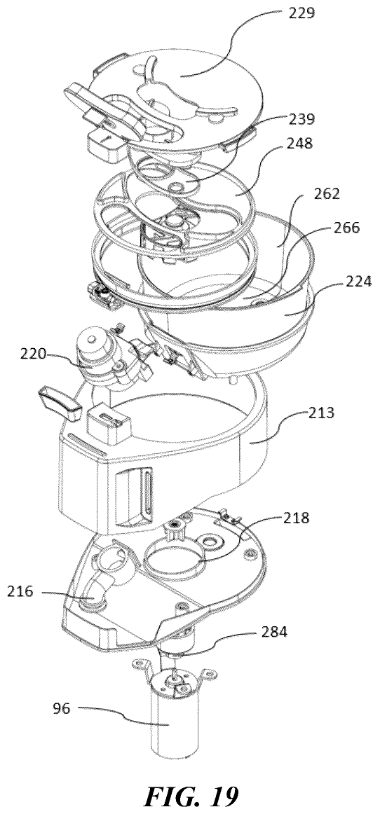

A dispensing valve 220, and a liquid valve connection 221 allows introduction of a fluid into the fluid reservoir 212. The reservoir 212 can be any suitable shape but in the preferred embodiment the mixing chamber housing can be the shape as shown in FIG. 19. The reservoir 212 can have a liquid dispensing hole 216, a motor hole 218, and a liquid valve hole 219.

The reservoir can be connected to a base 213. The base can have a first shelf 217 and can couple to the upper housing 212 by such as, for example, snaps, clips, adhesive, fasteners or the like.

The lid 228 of the mixing system has a powder inlet 240 through which a powder may be dispensed into the fluid reservoir 212. The powder inlet 240 is on a hole slider 230 that allows the powder inlet 240 to be rotatable between an open and a closed position. The lid may also have a port 226 and a port lid 232.

The lid 228 may have a top panel 229, a slider tray 248 and a lid bottom 235. The slider 230 is placed within a cutout in the slider tray 248 resting atop the lid bottom 235. The lid bottom has an opening 236 and a closed recess 237. When the powder inlet 240 is rotated above the opening 236 powder may be dispensed into the reservoir 212 and when the powder inlet 240 is above the closed recess 237 the closed recess on the lid bottom 235 prevents any powder from entering the reservoir 212.

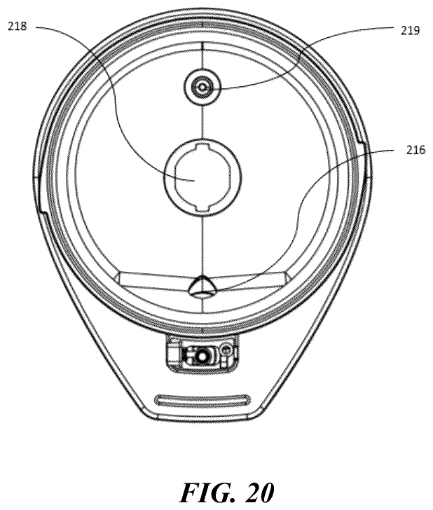

The hole slider 230 has a slide rail 231 that interacts with a slider guide 233 that directs and constrains the movement of the slider 230. The slider guide 233 can be integral to the mixing chamber lid or it can be separate and coupled to the mixing chamber lid. The slider guide 233 can be at least one groove or guide, as shown in FIG. 20, that can accept and guide a mixing chamber slider 230.

The slider rail 231 and the slider guide 233 can be substantially the same shape wherein the slider rail can follow the inside of the slider guide wherein the slider rail and slider guide can be such as, for example, square, circular, rectangular, or the like in shape. The mixing chamber slider 230 can follow the slider guide 242 wherein the slider guide can be such as, for example, a channel, groove, or the like. The mixing chamber slider 230 can move from an open position to a closed position aligning the powder inlet 240 with the slider hole 231 allowing powders to be dropped into the mixing chamber. The mixing chamber slider 230 can have at least one magnet (not shown) that can hold the slider open or closed.

The mixing chamber slider 230 can slowly add powder at the beginning of a mix cycle, which can prevent the powder from agglomerating and/or sticking to sides of the reservoir 212, which can also allow the mixture to slow increase in its viscosity, resulting in a quieter, smaller motor that produces a better outcome than traditional blending methods in faster times. The powder can be mixed into a liquid in an already low-speed mix cycle which can limit air-incorporation, then once powder is fully dispensed and dispersed, the speed of the mixing blade increases to further shear down the product particles within in the liquid mixture.

The mixing chamber lid 228 can have a port 226 wherein a port lid 232 can be removably coupled to the mixing chamber lid 228 by a port hinge 244 which can allow the port lid to open and close. The port lid 232 can have a second porthole 246 and a second port hole cover 238 wherein the port hole cover can be removably coupled to the second port hole. The port hole cover 238 can be made from such as, for example, rubber, plastic, metal, or the like. The port hole cover 238 can be a steam/pressure valve wherein as hot liquids enter the mixing chamber the port hole cover can release the pressure or steam, so the mixing chamber does not get pressurized. The port hole cover 238 can be such as, for example, pressure relief valve, air release valve, check valve, duckbill valve, one-way valve or the like.

The liquid dispensing hole 216 can allow the dispensing valve 220 to be couple and sealed to reservoir 212 by such as, for example, adhesive, fasteners, rivets, press fit, or the like. The dispensing valve 220 can be any mechanical or electrical valve having a dispensing hole and can be, such as, for example, check valve, solenoid valve, gate valve, mixing valve, or the like. The dispensing valve 220 can be open and closed by an electrical signal and can measure the flow of the liquid and how much the liquid is being dispensed.

The liquid valve connection 221 can be such as, for example, one way valve, check valve, ball valve, flap valve, non-return valve, cross-slit valve or the like allowing the liquid to flow from an outside liquid source to the inside of the mixing chamber 224 without allowing liquid to flow out of the mixing chamber. The liquid valve connection 221 can be coupled to the reservoir 212 creating a watertight seal by such as, for example, adhesive, fasteners, rivets, press fit, or the like. In certain embodiments, the liquid valve connection 221 can be integral to the reservoir 212.

The mixer 270 can simultaneously pull liquid, powder, and product from both the top and bottom of the mixing chamber during a batched mixing cycle rapidly ‘wet’ powders and can disperse ingredients to create agglomerate-free mixtures and more stable emulsions. The motor 96 can be such as, for example, DC motor, stepper motor, AC motor, brushless motor, or the like. The mixing chamber system 210 can further comprise an electrical system that can control the powder dispenser, the speed of the motor 96 and dispensing valve 220.

Further the mixing chamber can also relate to a method of mixing a fluid. The method comprises the steps of providing a powder dispenser arranged over the fluid mixer, introducing at least one liquid into the fluid reservoir 212 and at least one powder into the powder dispenser, and activating the motor 96 to rotate the stirrer 273. The powder is dispensed from the powder dispenser 240 into the liquid while the stirrer 273 is rotating. The method further comprises the steps of allowing a user to set a predetermined volume of the liquid and a predetermined weight of the powder, introducing the predetermined volume of the liquid into the fluid reservoir, and dispensing the predetermined weight of the powder from the powder dispenser.

The method further comprises the steps of introducing the liquid into the fluid reservoir 212 through a liquid inlet 216, and introducing the powder into the fluid reservoir 212 through a powder inlet 240. The liquid inlet 216 introduces the liquid into the outer portion 277 of the fluid reservoir 212. The powder inlet 240 is at least partially above the inner portion 275 of the fluid reservoir 212. When the powder is introduced through the powder inlet 240, at least a portion of the powder falls into the inner portion 275 of the fluid reservoir 212. The method further comprises the step of allowing a user to set the rotation speed of the stirrer 273 between 1 rpm and 15,000 rpm. The method further comprises the step of stirring the powder as the powder is being dispensed from the powder dispenser to prevent clumping allowing for a more uniform powder distribution on dispensing the powder into the mixing assembly 210.

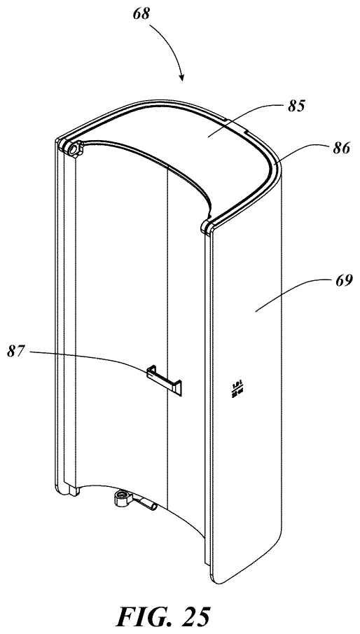

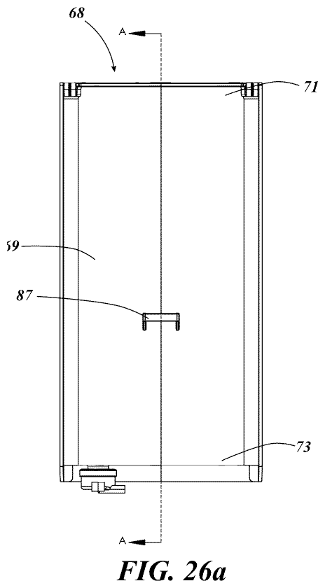

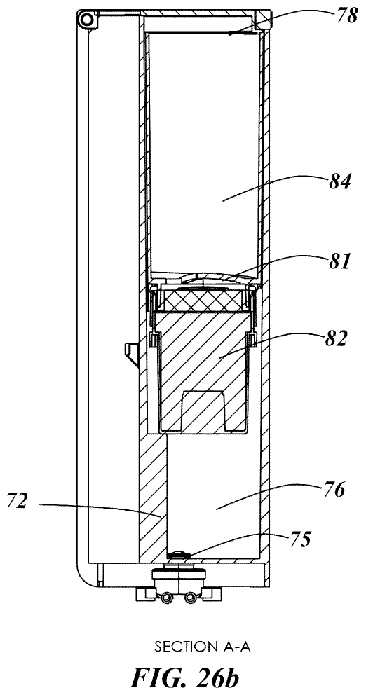

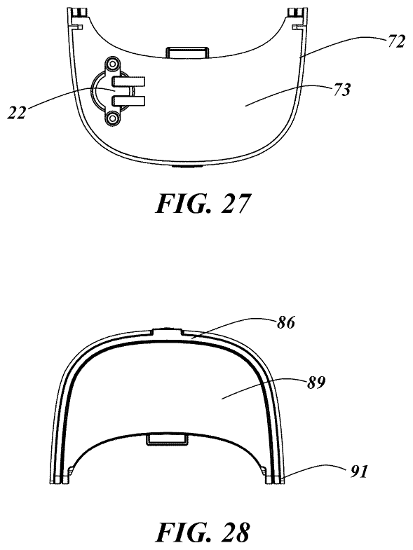

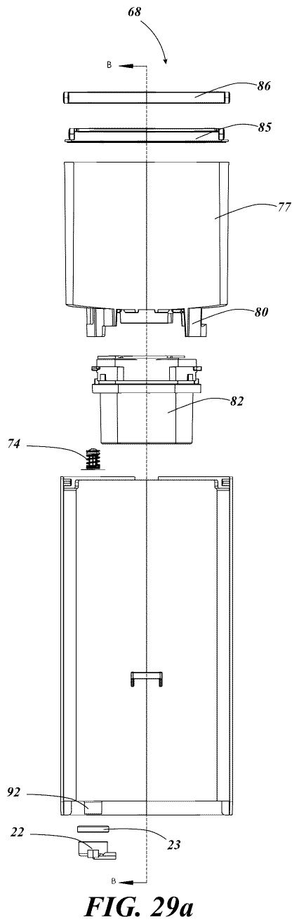

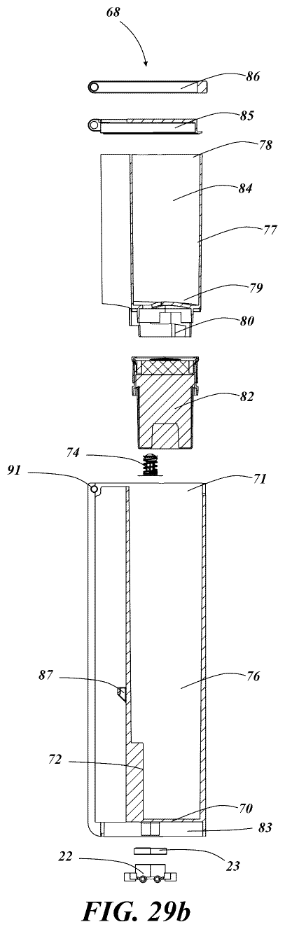

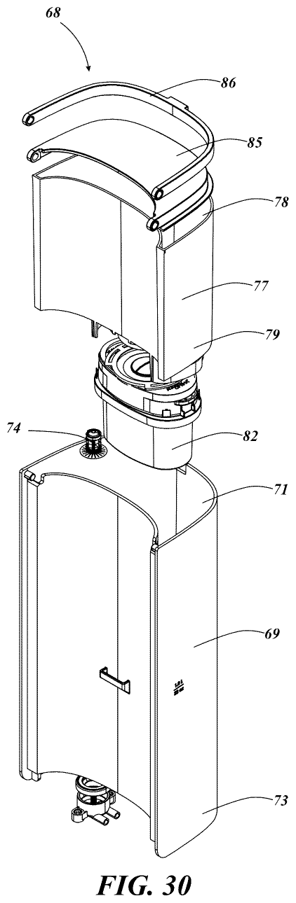

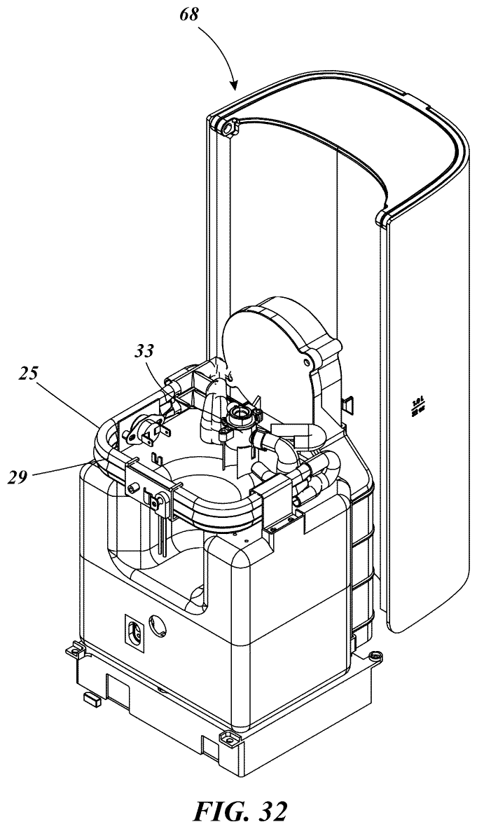

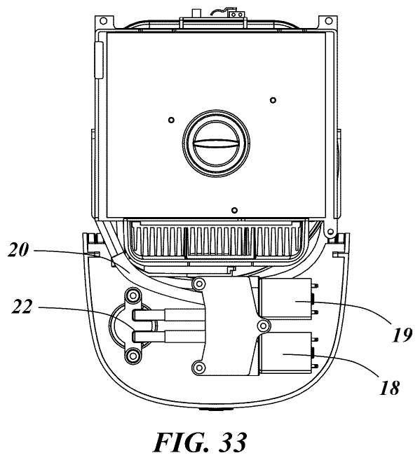

Referring to FIGS. 25-33 a liquid storage system for a powder and liquid mixing system is shown generally at 68. The liquid storage system 68 can comprise a storage tank 69 and a filling tank 77. The filling tank 77 can be removably coupled to the inside of the storage tank 69, creating a storage chamber 76 in the storage tank and a filling chamber 84 in the filling tank. The filling tank 77 can have a first end 78 that is open and a second end 79 that is closed, with a filtration hole 81. The second end 79 of the filling tank 77 can also include a filter holder 80 that allows a filter 82 to be removably coupled to it. The filling tank 77 can be inserted and removably coupled to the storage tank 69 allowing the user to be able to remove and clean both the filling tank and the storage tank. The filling tank 77 can be outer shape can be substantially the same shape as the storage tank's 69 inner shape and can be a loose fit allowing the filling tank to easily be inserted into the storage tank. The filling tank 77 can be a volume that is substantially smaller than the storage tank's 69 volume allowing the liquid to sit in both the filling tank and the storage tank.

The filling tank 77 can have a filtration hole 81 on the filling tank's second end which can be a closed end. The filtration tank's 77 first end can be open allowing a user to put liquid in the filling chamber 84. The filtration hole 81 can allow the liquid to flow through a filter 82 and down into the storage chamber 76 where the liquid can wait until. In certain embodiments, the filtration hole 81 can have a valve on it selectively allowing the liquid within the filling chamber 84 to enter the storage chamber 76 when needed. In embodiments, the filter can be such as, for example, mechanical filter, absorption system, sequestration filters, io exchange filters, reverse osmosis, or the like. The filter 82 can be attached to the filling tank by a filter holder 80 and can be sealed against the filling tank 77 wherein the liquid can only flow through the filter into the storage chamber through the filtration hole 81 and the filter. In certain embodiments the filter 82 can be inside the filling tank 77 and coupled to it by a filtration hole or it can be sealed against the filling tank by at least one tab.

In embodiments, the storage chamber 76 can have a support 72 wherein the support can be abutted up to the filter supporting the filter 82 and the filling tank 77 at a set height from a storage tank's bottom 70 which can be such as, for example, between 1 inch to 10 inches and more preferably 2 inches to 7 inches and still more preferable 3 inches. The storage chamber 76 can store such as, for example, between ¼ cup to 40 cups and more preferably 2 cups to 10 cups and still more preferable 5 cups. The filling chamber 84 can store such as, for example, between ¼ cup to 40 cups and more preferably 2 cups to 10 cups and still more preferable 5 cups. The storage chamber 76 can store substantially more liquid or substantially less liquid than the filling tank 77. The storage tank 69 can have a pivot joint 91 integral to its first end 71 wherein a lid 85 and a handle 86 can be rotatable attached to the pivot joint covering the filling tank and the storage chamber's first end 71.

The storage tank 69 can have a second end 73 which can be integral to the tank's bottom 70 wherein the second end can extend past the bottom forming a tank support 83 which can support the storage tank when installed into a base. The storage tank 69 can have a bottom 70 that can have a piston hole 75 wherein the piston hole can be coupled to the piston 74. The piston 74 can be coupled to the piston hole by such as, for example, press fit, welded, screwed, adhesive, or the like. The piston 74 can have an O-ring 23 which can seal against the hole or protrusion keeping the liquid from leaking out of the storage chamber 76. The piston 74 can be such as, for example, piston valve, on/off valve, solenoid valve, push valve, check valve, or the like. The piston 74 can be in at least two positions for example, when pushed against the piston can be open allowing the liquid to flow and when not pushing the piston is closed keeping the liquid within the storage tank 69.

The storage tank 69 can have a hinge 87 coupled to it on the outside or inside of the main tank substantially near the storage tank's second end 73 and can be on the front side of the storage tank where to an external body. The hinge 87 can be such as, for example, magnet, flexible magnet, protrusion, hanger, tab, or the like. In certain embodiments the filling tank 77 can have a guide when inserted into the storage tank 69 that allows the filling tank to stay centered and sealed against the storage tank. The storage tank 69 and the filling tank 77 can be made from the same material or different materials such as, for example, plastics, metals, ceramics, or the like and can be made from one piece or multiple pieces.

The valve 22 can be coupled to at least one pump wherein in the preferred embodiment there at least two pumps a first pump 18 and a second pump 19. The pumps 18 can be such as, for example, micro-pump, centrifugal pump, positive displacement, axial flow or the like. The pumps 18 can be coupled to tubing 20 wherein at least one valve 22 can be coupled to the tubing that runs to the first pump 18 and the second pump 19. The valve 22 can be such as, for example, three-way valve, check valve, two-way valve, gate valve, pressure relief valve, or the like. The valve 22 can be coupled by tubing 20 to either the cooling tank 24 or the heating mechanism 21 by at least one tube having a pump that can pull or push the liquid into the cooling tank or the heating mechanism.

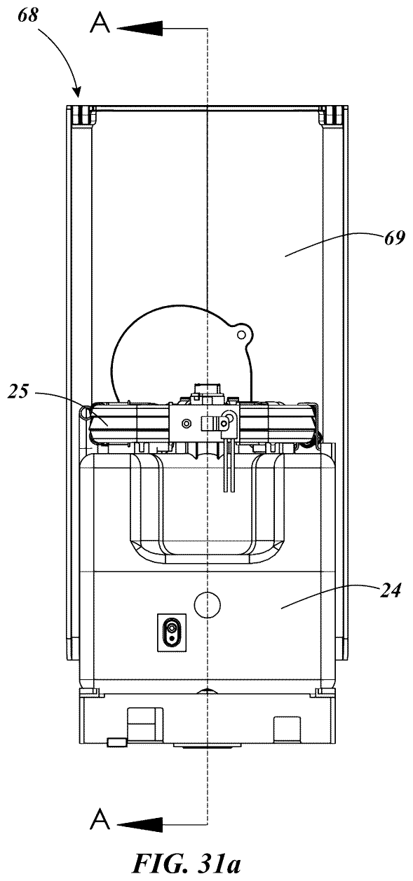

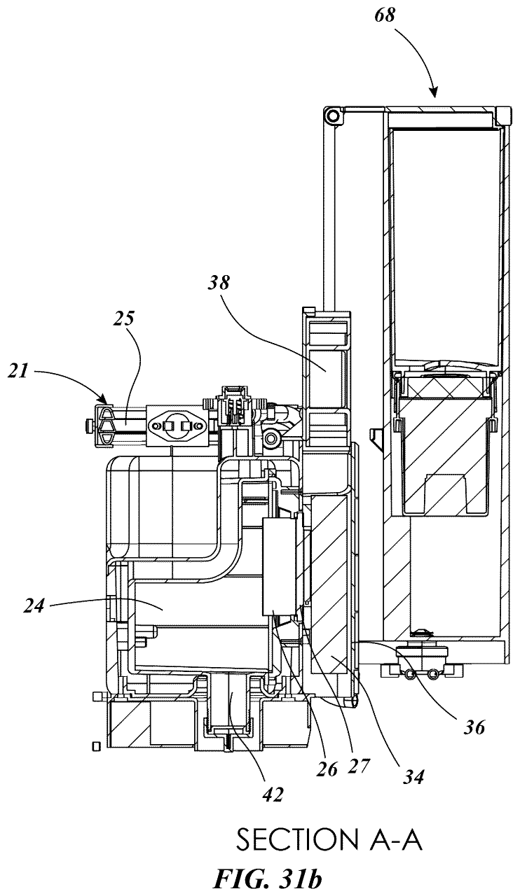

The cooling tank 24 can be insulated with at least two walls and includes a drain 42. The cooling tank 24 can have at least one cooling fin 26 coupled to at least one thermal electric cooler 27, which can be a Peltier device. The thermal electric cooler 27 can be coupled to a heat sink 34 and can be covered with a cover 36 with a fan 38 coupled to it. The fan 38 directs air through the cover 36 and away from the heat sink 34. The heating mechanism 21 can comprise at least one heating coil 25 which can be coupled to at least one heating tube 29 that can bend back around its same path as shown in FIG. 31. The heating mechanism 21 can allows for the efficient heating of the liquid before when it released from the storage tank into the system.

[The at least one tube 20 can be coupled to a cooling tank 24 and a heating mechanism 21 wherein a second valve can selectively open and close when a user calls for hot or cold liquid. The cooling tank 24 can be any suitable size or shape but in the preferred embodiment the cooling tank is as shown in FIG. 31. The cooling tank 24 can have a cooling tank hole on at least one of its sides, wherein the preferred embodiment the cooling tank hole is on its top side wherein the hole can be coupled to a second valve 33 which can selectively release hot liquid or cold liquid. The second valve 33 can be coupled to at least one tube 20 which leads to or from the pump 18 wherein in certain embodiments a check valve can be coupled between the tubes keeping the liquid from flowing in the opposite direction towards the storage chamber 76.

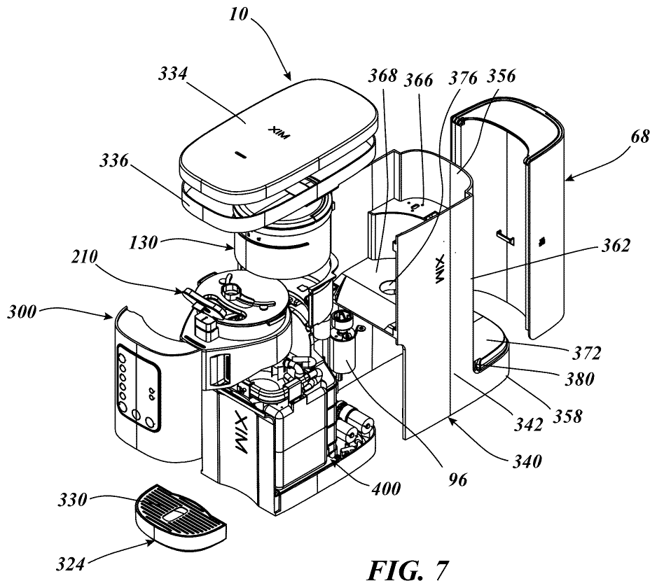

The cooling tank 24 can be coupled to a heatsink 34 wherein the heatsink can be coupled to a thermoelectric cooler, such as a Peltier device (not shown) or cooling blanket, or the like, which can allow for the tank to cool the liquid down to a user specified set temperature. The heatsink 34 can be covered by a heat sink cover 36 wherein the heat sink cover can protect the heatsink and direct the air from a radial fan 38 into the heat sink and through a base plate slot 46 out of the system, cooling the heat sink and wicking away the heat from the thermoelectric cooler. The cooling tank 24 can be shell with an opening on at least one of its sides allowing for the heatsink 34 to be sealed and coupled to the cooling tank 24. The cooling tank 24 can be any suitable shape or size but in the preferred embodiment the shape is as shown in FIG. 7.

The heatsink 34 can be sealed to the cooling tank 24 by such as, for example, adhesive, fastener, RTV, or the like. The heatsink 34 can be such as, for example, bonded heatsink, extruded heat sink, stamped heat sink, forged heat sink, or the like. The temperature of the liquid can be set from at least 33 degrees Fahrenheit to at least 150 degrees Fahrenheit. The liquid can be such as, for example, tap water, distilled water, alkaline water, or the like.

The liquid storage system 68 can provide a versatile and efficient solution for storing and controlling the temperature of liquids. The system's unique design allows for easy removal and replacement of the filter, and the inclusion of both a cooling tank and a heating mechanism ensures that the liquid can be maintained at the desired temperature. The use of a thermoelectric cooler and a heat sink further enhances the system's ability to control the temperature of the liquid.

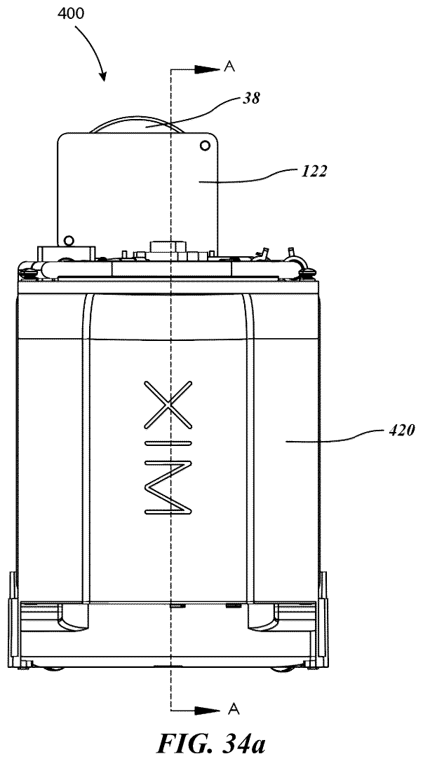

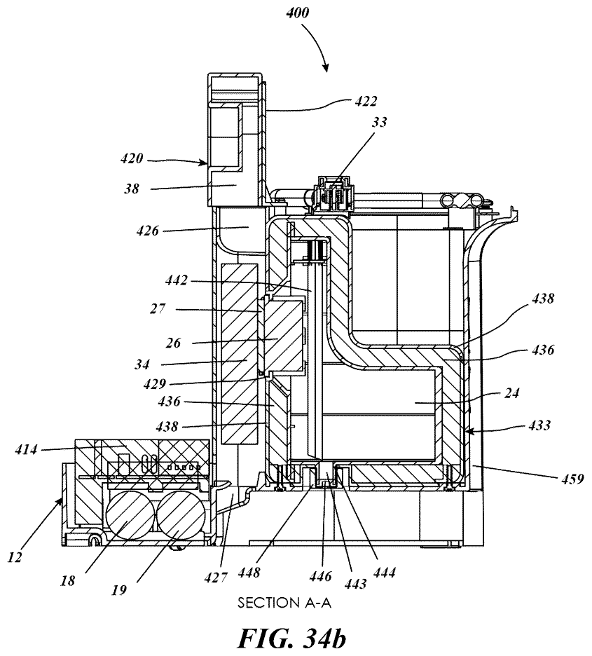

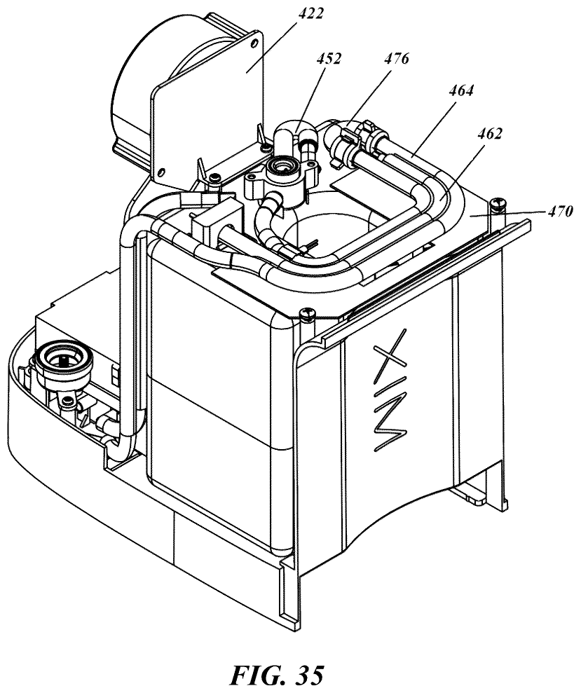

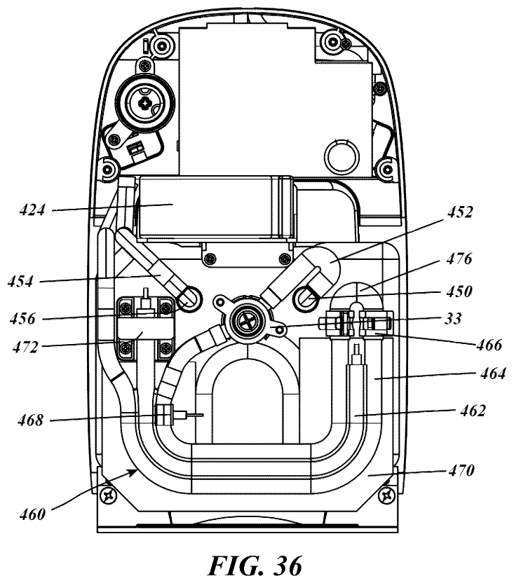

Referring initially to FIG. 34a-37 a cooling and heating system is shown generally at 100 for the powder and liquid mixing device 10 which can comprise a cooling section 420 and a heating section 460. The cooling section 420 can comprise a cooling element 27 which can be coupled to a cooling fin 26 on one side and a heat sink 34 on the other side. The cooling element 27 can be such as, for example, thermal electric cooler (“TEC”), thermocyclers, single state, multi-stage, mechanical-compression refrigerator, or the like. The cooling element 27 can have a hot side and a cold side wherein the cold side can be coupled to the cooling fin 36 and the hot side can be coupled to the heat sink 34. The cooling fin 27 can be such as, for example, rectangular fin, triangular fin, longitudinal fin, concave fin or the like. The heat sink 34 can be such as, for example, active heat sink, passive heat sink, extruded heat sink, bonded heat sink, forged heat sink, or the like. A thermal paste (not shown) can be placed between the cooling element 27 and the heat sink 34 to allow for efficient heat transfer between the cooling element and heat sink.

The cooling fins 26 can be sealed to the cooling tank 433 wherein the cooling fan can be sealed against the outside or the inside of the cooling tank. The cooling fins 26 can protrude into the cooling tank 433 allowing the liquid to come into contact with the cooling fins resulting in the liquid to cool down and sit at a user's specified set temperature. The cooling tank 433 can have an inner wall 434 and an outer wall 438 with an insulation layer 436 between the two walls. The insulation layer 136 can be such as, for example, spray foam, rigid foam, radiant barrier, cellulose insulation, wool, fiber glass, or the like. The insulation layer 434 can be placed or sprayed between the inner wall and the outer wall. The cooling tank 433 can be made from more than one piece for the inner wall 434 and the outer wall 438 and can be any suitable size or shape.

The cooling tank 433 can have at least one hole wherein in the preferred embodiment the at least one hole is a first hole 429 and a second hole 443. The first hole 429 can be configured to hold and couple to the cooling fin 26 and second hole 443 can be configured and coupled to a drain port 444. The cooling fin 430 can be sealed against the first hole 429 creating a watertight seal. The drain port 444 can have a drain plug 446 and a drain cover 448 removably coupled to it wherein the drain plug can allow the user to empty the cooling tank. The cooling tank 433 can have cooling tank slot 435 to allow for a mixing motor 96 that can be connected to a mixing tank 16. In certain embodiments the drain port 444 can be omitted or placed on a side wall of the cooling tank 433.

In embodiments, the cooling section 420 can further comprise fan 38 that can be coupled to a fan mount 422 that can support the fan wherein the fan mount can be coupled to the cooling tank 433. The fan 38 can further be coupled to a fan duct 426 wherein the fan can pull cool air from outside of the powder and liquid mixing device 10 and the fan duct can direct the air towards the heat sink wherein the cool air can be pushed across the heat sink, cooling the heat sink, and then pushing the now hot air out of the powder and liquid mixing device at the fan duct's exit 427. The fan 38 can be such as, for example, radial fan, axial fan, propeller fans, centrifugal fan, mixed flow fan, cross fan, or the like. The fan 38 can be couped and sealed to the fan duct 126 by such as, for example, adhesive, silicone, O-ring, or the like.

The cooling section 420 can further comprise a first pump 18 that is coupled to a cooling tube inlet 454 wherein the cooling tube can be coupled to the cooling tank 433 by a cooling tube connection 456. The first pump 18 can pull a liquid from a first chamber 76 of the liquid filtration 68 and push it through the cooling tube inlet 454 into the cooling tank 433. The liquid can sit in the cooling tank 433 and be cooled by the cooling fins 130. The user can set the temperature of the liquid by a microcontroller unit (“MCU”) and at least one sensor (not shown) in the cooling tank 133. The at least one sensor can be such as, for example, thermocouple, thermistor, RTS sensor, infrared sensor, or the like. The first pump 114 and the MCU can control the amount of liquid entering the cooling tank 133.

The cooling section 420 can further comprise at least one outlet straw 442 that can be coupled to the cooling tank 433. The outlet straw 442 extend from the top of the cooling tank 433 to substantially near the bottom of the cooling tank. The outlet straw 442 can be coupled to the cooling tank 433 by a cooling tube connection 450 wherein the cooling tube connection can be coupled and sealed to the cooling tank by such as, for example, a clamp nut, adhesive, press fit, or the like. The cooling tube connection 450 can be coupled to a cooling tube exit 152 wherein the cooling tube exit 452 can be coupled to a valve 33. The valve 33 can be such as, for example, three-way valve, check valve, two-way valve, gate valve, pressure relief valve, solenoid valve, or the like. The valve 3 can allow for the liquid to be pulled from the cooling tank 433 to the mixing chamber 16.

The heating section 460 can comprise a second pump 19 that can be coupled to a heating tube 464 wherein the heating tube can extend from the second pump to the top of the cooling tank 433 wherein the heating tube can substantially follow the same path back onto itself with at least one heating coil between the heating tubes. The heating coil 462 can follow the substantially same path as the heating tubes 464 and the heating coils can be coupled to heating tubes on at least two heating tube locations. The heating coils 462 can be connected to a heating element 174 which can be coupled to the cooling tank by a heat clamp 472 wherein the heat clamp can contain and couple to the heating element wherein the heating coils are coupled to or come into contact with the heating element. A heat shield 470 can be placed between the heating coils and the cooling tank 433 wherein the heat shield can act as a thermo barrier and prevent cooling tank from heating up.

The heating coils 462 can be such as, for example, electric coils, infrared heater, condenser coil, tubular heaters, team oils, heating elements, heat pipes, or the like. The heating element 474 can be such as, for example, metal heating element, composite elements, electrical heating element or the like. The heating element 474 can heat up the heating coil 462 wherein the as the liquid passes by the heating coil in the heating tubes, the liquid will heat up to the user's desired temperature. A heat temperature sensor 168 can be coupled to the heating tube 164 and/or the heating coils wherein the MCU can control whether heat is required to reach the user's desired liquid temperature. In certain embodiments, the heating tubes 164 can be supported by and coupled to at least one heating tube clamp 466 which can allow for the heating tubes to be connected to a one hundred-and eight-degree bend fitting 476 which can allow the heating tube to overlap back on the partially the same path to the valve 33. In certain embodiments the heating tube 164 can be supported by and coupled to the cooling tank 433. The heating tube clamp 166 can be such as, for example, tube clamps, routing clamps, or the like.

In embodiments, the heating tube 464 can be coupled to the valve 33 wherein the valve can switch between the heating section and the cooling section depending on the user's needs. The cooling tube inlet 454, cooling tube exit 452, heating tube 464 can be such as, for example, ethyl vinyl acetate tubing, nylon tubing, polycarbonate tubing, polypropylene tubing, rubber tubing, or the like. The first pump 18 and the second pump 19 can be such as, for example, centrifugal pump, diaphragm pump, axial-flow pump, rotary pump, gear pumps, or the like. The temperature of the liquid can be set from at least 33 degrees Fahrenheit to at least 150 degrees Fahrenheit. The liquid can be such as, for example, tap water, distilled water, alkaline water, or the like.

The powder and liquid mixing system 10 can comprise a bottom assembly that can have a mixing chamber 210 coupled to it. The mixing chamber 210 can have a powder dispensing hopper 130, which can be powder hopper or hopper, can be removably coupled to the mixing chamber wherein the mixing chamber and the hopper can be supported by a top assembly 340. The top assembly 340 can have the liquid filtration device 68 coupled to its back end and a front assembly 300 coupled to its front end wherein the front assembly can be removably attached to the top assembly by at least one hinge that is integral or coupled to the top assembly. The front assembly 300, the hopper 130, the top assembly 340 and the liquid filtration 68 can be covered by a lid 334 wherein the bottom assembly 12 can be coupled to a drip tray 324.

Referring back to FIG. 1 the drip tray 324 can be removably coupled to the bottom assembly 12 and can be flush with the bottom assembly and/or can support the bottom assembly. In other embodiments, the drip tray 324 can sit below or higher than the bottom assembly 12. In embodiments, the drip tray 324 can be removable from the bottom assembly 12 and can have a drip tray first piece and a drip tray second piece wherein the first piece can have a plurality of drip tray holes 330 which can allow liquids to be collected in the drip tray second piece wherein the drip tray second piece can be partially a shell with an open top to allow the drip tray first piece to fit within the second piece. The drip tray 324 can extend partially in front of the bottom assembly allowing for a cup, bottle or the like to be held while the liquid is being dispensed.

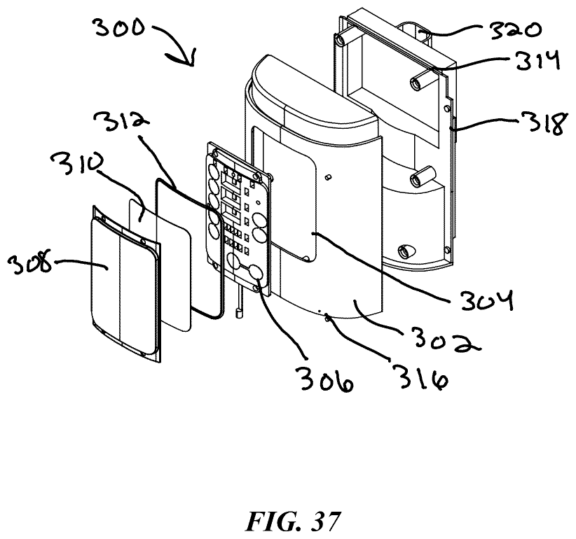

Referring now to FIG. 37 the powder mixing system 10 can further comprise a front assembly 300 wherein the front assembly can have a front door 302 coupled to a PCB casing 306. The front door 302 can have a front door hole 304 wherein a screen 308, a PCB lightguide frame 310, a screen rim 312 can be couple and fit within the front door and the front door hole. The front door hole 304 can be sized to fit the screen 308 wherein the screen can be such as, for example, LED, LCD, OLED or the like. The front door 302 and a PCB casing 314 can be any suitable size or shape but in the preferred embodiment the front. The front door 302 can have at least one front door hinge 318. The PCB casing 314 can be coupled to the front door 302 by such as, for example, fastener, adhesive, rivets, hinged, press fit, or the like. The PCB casing 314 can have at least one PCB hinge 318 and a PCB slot 320.

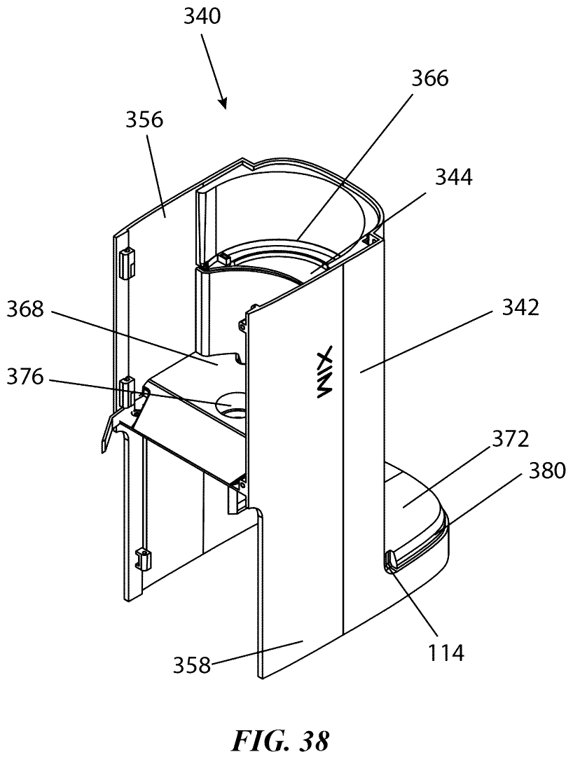

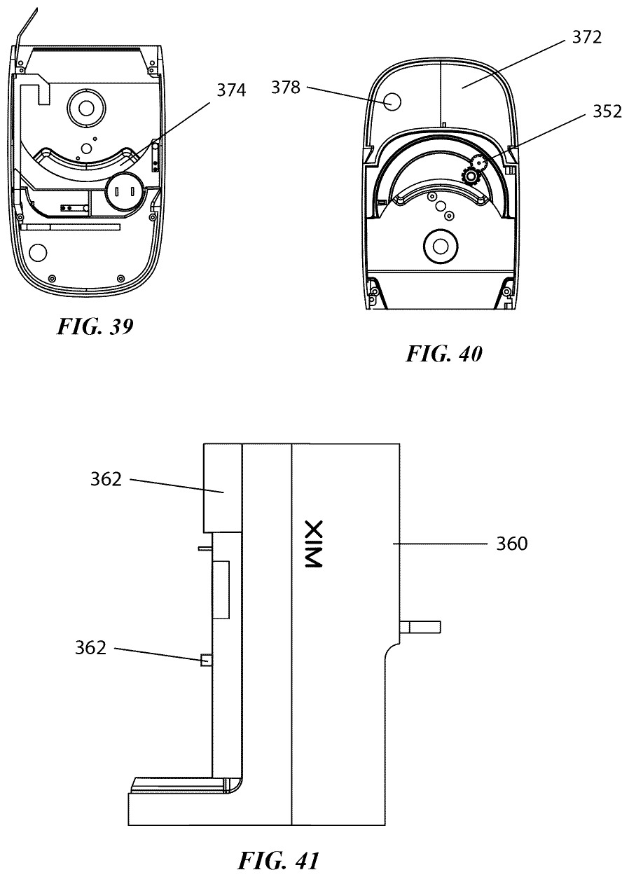

Referring to FIG. 38-41 wherein the top assembly 340 wherein the top assembly can comprise a main housing 342. The main housing 342 can have a main housing first end 356, a main housing second end 358, a main housing front end 360, and a main housing back end 362 wherein the housing can be any suitable shape or size, but in the preferred embodiment the housing creating a partial outer shell for the powder mixing system 10 components. The main housing 342 can further comprise a first shelf 366, a second shelf 268, and a third shelf 372 wherein the first shelf can support a hopper holder 344.

The hopper holder 344 can substantially take on the substantially same shape as the main housing 342 on its hopper holder's first side and the main housing can have a mixing chamber slot 374 wherein a mixing chamber can be inserted into and attached or coupled to the main housing. The hopper holder 344 can have a hopper motor hole 376 which can allow the powder motor 94 to be coupled to it. The powder motor 94 can be attached to the hopper holder 344 by such as, for example, press fit, adhesive, fasteners or the like. The powder motor 94 can be attached to a small hopper gear 102. The hopper holder 344 can have at least one force sensor 180 connected to it wherein in the preferred embodiment the load cells can be located on both sides and the back of the hopper assembly 130 wherein the force sensor can weight the contents of the hopper. The force sensor 180 can be such, as for example, pancake load cell, diaphragm, single column, donut, cannister, single point or the like. The force sensor 180 can measure the powder's current weight and change in weight as the powder is dispensed from the powder hopper 130 for the user to use precision dosing of the powder.

The powder mixing system 10 can further comprise a mixing chamber motor 290 wherein the mixing chamber motor can be coupled to the second shelf 368 by such as, for example, fasteners, adhesive, weld, press fit, or the like. The second shelf 368 can have a mixing motor hole 376 to allow for the motor shaft to pass through the second shelf. The load cells 180, hopper motor 100 and mixing chamber motor 290 can have cables 98 that run through the top assembly to a controller (not shown). The mixing chamber motor 290 and the hopper motor 100 can be such as, for example, a stepper motor, ac motor, dc motor, direct drive, linear motor, servo motor or the like.

The main housing 342 can further comprise a main housing first hole 370 and the third shelf 372 can have main housing second hole 378 wherein the main housing second hole can allow for the piston 74 to be inserted into from the water tank assembly 68. The third shelf 372 can have at least one main housing slot 364 wherein the notch can allow for the at least one water tank key (not shown) to be inserted into the slot keeping the liquid filtration device 68 onto the main housing 342. The third shelf 372 can have a groove 380 around the outside circumference allowing the water tank flange to mate up with the groove.

The hopper motor 100 can rotate in both directions wherein if the hopper motor turns to the left the hopper valve opens and if it turns to the right the hopper valves are closed. If the hopper assembly 130 is remove from the system a hopper valve spring (not shown) closes the valve automatically so it can be stored safely.

In embodiments, the after each use the powder mixing system 10 can dispense ‘hot water’ to sterilize and rinse the mixing chamber after each use, or upon user request by the user (manual button). This auto-rinse kills bacteria and removes any potential remnants from the mixing cycle left in the chamber or on the mixing unit. After the rinse cycle-the solution is dispensed directly into the drip-tray residue container where the user can then remove the residue from the drip-tray from the powder mixing system and can be emptied down the kitchen drain. From start to finish (powder being dispensed, mixed into liquid and dispensed for drinking) can be completed within or under 60-70 seconds depending on if user adds additional product such as, for example, fruits, nuts or the like into the mixtures. Through the hatch on the mixing chamber lid, a user can add supplemental ingredients such as a banana or strawberry while the machine is on or off.

The method also includes stirring the powder as the powder is being dispensed. A slide valve 151, which can be an access slide, is provided at the dispenser hole 144, and the slide valve is closed when the selected amount of powder has been dispensed. A dosage wheel 160 can provided to the hopper 130, wherein the dosage wheel has at least one slot 148 with a predetermined volume and rotating the at least one slot over the dispenser hole to dispense the predetermined volume to the mix chamber 210. The method also includes providing a plurality of dosage wheels, each dosage wheel having a different number of slots with a predetermined volume. The user is allowed to select one of the plurality of dosage wheels based on the amount of powder to be dispensed. The selected dosage wheel is rotated over the dispenser hole to dispense the predetermined volume to the mix chamber. The method also includes cooling or heating the volume of liquid and providing the liquid to the mixing chamber. The top of the slot is scraped before the slot is rotated over the dispensing hole. The method also includes providing a plurality of hoppers, each of the plurality of hoppers having an airtight lid sealing the top of the hopper and an airtight cap sealing the dispenser hole of the hopper for storing a plurality of powders. The hopper can be selected and inserted above the mix chamber.

A method of complete dispersion for lump free/agglomerate free mixes by adding powder slowly at the beginning of the mix cycle which can help prevent powders from agglomerating and/or sticking to sides of the mixing chamber. By mixing slowly the viscosity can be increased, which means we can the powder mixing system can be quieter with a smaller motor and still produce equal to better outcomes than traditional methods in faster times and by mixing slowing and speeding up the low-speed mix cycle limits air-incorporation, then once powder is fully dispensed and dispersed, the speed of the mixing blade increases to further shear down the product particles within in the liquid mixture. Dosing the powder through at least five (5) slots allowing the powder to drop quicker, and in smaller increments to better control excess powder being dropped. The volume control can assist the weighted dosing method that can be used because the hoppers can tolerate multiple powder types variances and densities and supports different brand formulas with same degree of precision in dosing.

The opening and closing mechanism on the bottom of hopper protects the powder from steam (when mixing hot drinks) and protects from possible splashing during mix cycles. It also lets user completely detach and store the hopper elsewhere without having any powder leaked or spilled from the bottom while removing it or storing it. It also protects the powder by reducing the amount of air/light exposed to it. The mixer can simultaneously pull liquid, powder, and product from both the top and bottom during the batched mixing cycle rapidly ‘wet’ powders and disperse ingredients to create agglomerate-free mixtures and more stable emulsions in some cases. The powders can be added from the surface (top) are difficult to wet and difficult to disperse, which creates “lumps”/agglomerates in the mixture. Weighing the hopper before, during and after the powder is dispensed into the liquid to be mixed such that the user can get precise measurements of powder disbursed into the liquid. The mixer can pull the liquid, powder and product from both the top and bottom during the mixing process.

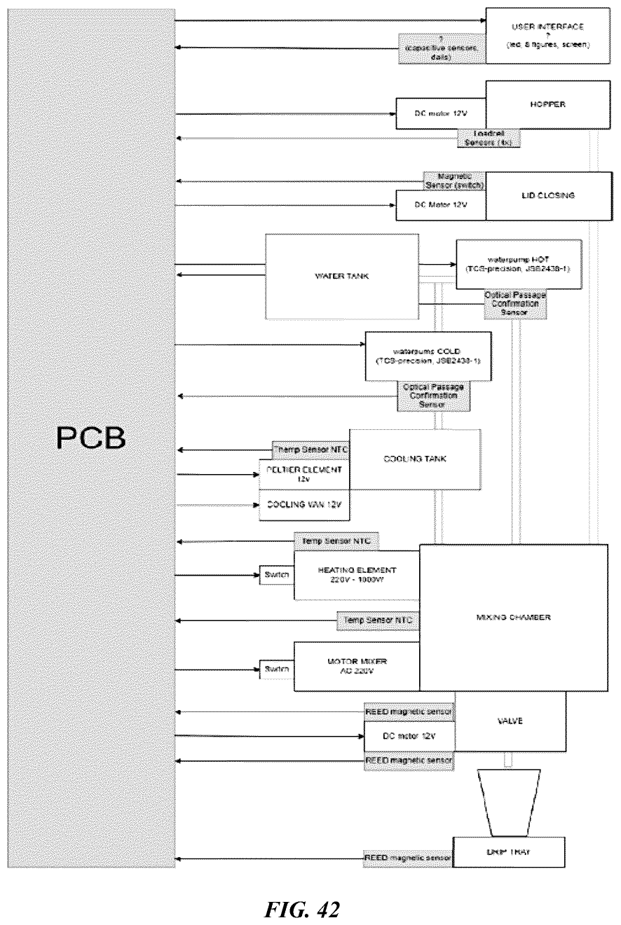

Referring to FIG. 42 shows an electrical wiring diagram of the liquid and powder mixing system wherein the user can have an interface that allows the user to select the temperature of the liquid to be dispensed, the amount of protein to be dispensed, the type of protein such as whether it is thick or think granules, the amount of liquid to be put in for the amount of powder wherein the powder can be such as, for example, protein powder, baby formula, or any other powders that needs to be mixed with a liquid and heated or cooled. The liquid can be filtered and stored in the storage tank waiting for the printed circuit board to call for the water. Additionally, liquid can be pulled from the storage tank and put into the cooling tank awaiting for the programming to call for the cooled liquid. Once the liquid is called it is pulled from the either the cooling tank or the storage tank depending on if cool or hot liquid is needed and placed into the mixing chamber. The mixing chamber motor slowly starts to rotate the water or can wait for the powder to be dispensed. The powder hopper motor is activated and the dosing wheel and the stir wheel start to rotate mixing and declumping the powder, the hopper rotates at least 0 to 30 degrees opening the dispenser hole and dispensing 2 grams of powder per slot on the dosage wheel. The weight of the hopper and any components the force sensor see is taking before dispensing occurs and takes the delta as the powder is dispensed through the dispenser hole into the mixing chamber where the water is being turned. The powder is dispensed until the user specified or powder specified amount is dispensed. The hopper is then closed and the mixing motor increases its speed, mixing the liquid with the powder. The mixing motor is then turned off and a valve is opened and the liquid is dispensed into a user's cup.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

1. A liquid and powder mixing system comprising:
a mix chamber comprising a reservoir and a liquid powder stirrer, the reservoir configured to hold a predetermined amount of at least one liquid;
a removable hopper situated above the mix chamber to dispense at least one powder into the mix chamber, wherein the hopper is selectively sealed by an airtight lid and dispenses the at least one powder through a dispenser hole at a predetermined volume rate, wherein the dispenser hole has an airtight cap that seals the dispenser hole to allow the at least one powder to be storedin the hopper when the hopper is removed from the system;
a scale that continuously measures the weight of the at least one powder in the hopper;
a plurality of dosage wheels each having at least one slot having different powder dispensing rates with a predetermined volume;
a stopper that closes the dispenser hole when a desired amount of powder has been dispensed to the mix chamber.

2. The liquid powder mixing system of claim 1, wherein the system dispenses 0-90 grams of the at least one powder into the at least one liquid and mixes the at least one powder with the at least one liquid in under 60 seconds.

3. (canceled)

4. (canceled)

5. (canceled)

6. The liquid powder mixing system of claim 1 further comprising a scraper coupled in the hopper to scrape the top of the dosage wheel to ensure the appropriate volume is dispensed when the at least one cutout is rotated over the dispenser hole.

7. The liquid powder mixing system of claim 1 further comprising a stirrer situated in the hopper to declump the at least one powder as the at least one powder is being dispensed from the hopper.

8. The liquid powder mixing system of claim 1 wherein the at least one slot and the dispenser hole are substantially the same shape.

9. The liquid powder mixing system of claim 1 wherein the dosage wheel has a depth between 1/16 of an inch and ¼ of an inch.

10. The liquid powder mixing system of claim 1 wherein the volume of the at least one slot is between 0.75 and 1.5 milliliters.

11. The liquid powder mixing system of claim 1 wherein the hopper and the reservoir are removable and dishwasher safe.

12. (canceled)

13. A method of mixing at least one powder with at least one liquid, the method comprising the acts of:
providing a mix chamber comprising a reservoir and a liquid powder stirrer, the reservoir configured to hold a predetermined amount of at least one liquid;
providing a hopper situated above the mix chamber to dispense at least one powder into the mix chamber, wherein the hopper dispenses the at least one powder through a dispenser hole at a predetermined volume rate;
providing a scale that continuously measures the weight of the at least one powder in the hopper;
allow a user to select a weight amount of powder and a volume of liquid to be mixed;
dispense the powder at the predetermined volume rate and cease dispensing powder when the scale determines that the selected weight amount of powder has been dispensed;
mixing the volume of liquid and the weight amount of powder;
dispensing the mixed solution.

14. The method of claim 13 further comprising stirring the powder as the powder is being dispensed.

15. The method of claim 13 further comprising providing a slide valve at the dispenser hole, and closing the slide valve when the selected amount of powder has been dispensed.

16. The method of claim 13 further comprising providing a dosage wheel to the hopper, wherein the dosage wheel has at least one slot with a predetermined volume and rotating the at least one slot over the dispenser hole to dispense the predetermined volume to the mix chamber.

17. The method of claim 13 further comprising
providing a plurality of dosage wheels, each dosage wheel having a different number of slots with a predetermined volume;
allowing a user to select one of the plurality of dosage wheels based on the amount of powder to be dispensed;
rotating the selected dosage wheel over the dispenser hole to dispense the predetermined volume to the mix chamber.

18. The method of claim 13 further comprising cooling or heating the volume of liquid and providing the liquid to the mixing chamber.

19. The method of claim 16 further comprising scraping the top of the slot before the slot is rotated over the dispensing hole.

20. The method of claim 13 further comprising providing a plurality of hoppers, each of the plurality of hoppers having an airtight lid sealing the top of the hopper and an airtight cap sealing the dispenser hole of the hopper for storing a plurality of powders, wherein the hopper can be selected and inserted above the mix chamber.
